(19) United States
(12) Patent Application Publication
(10) Pub. No.: US 2015/0198528 A1
(43) Pub. Date: Jul. 16, 2015

(54) ASSAY DETECTION SYSTEM

(71) Applicant: Victor Manneh, Encinitas, CA (US)

(72) Inventor: Victor Manneh, Encinitas, CA (US)

(73) Assignee: Xen Biofluidx, Inc., San Diego, CA (US)

(21) Appl. No.: 14/153,031

(22) Filed: Jan. 11, 2014

(51) Int. Cl. G01N 21/64

(52) U.S. Cl. CPC G01N 21/64; G01N 2201/062; G01N 2201/12

(57) ABSTRACT

An assay system including reagents and devices for conducting rapid, high sensitivity analyte assays, including multiplexed assays, is described. The reagents and devices are adapted for performing time-resolved signal detection with low background due to non-specific binding. Also described are apparatus for use in measuring a luminescent property of a sample. The apparatus can use light emitting diodes for emitting radiation to excite the sample, under the control of a control signal. A signal generator generates the control signal for modulating the intensity of the emitted radiation. The control signal has a first component at a first frequency with a period that is less than, or of the same order as, an expected characteristic time constant of the luminescent property. The control signal has a second component at a second frequency with a period that is greater than the expected characteristic time constant of the luminescent property. A photosensor receives the radiation luminesced from the sample as a result of the excitation and detector circuitry generates a detection signal representing an intensity of the received radiation, and demodulates the detection signal to produce a signal representing the luminescent property of the sample.

### RELATED APPLICATIONS

This application is a continuation-in-part of Hayes and van Wyk, PCT/GB2012/051645 and of Manneh, U.S. patent application Ser. No. 13/709,398, filed Dec. 10, 2012, entitled Assay Detection System, and of Manneh, U.S. patent application Ser. No. 12/711,226 filed 23 Feb. 2010, which claims the benefit of Manneh, U.S. Prov Appl 61/154,593 filed 23 Feb. 2009, and Manneh, U.S. Prov Appl 61/304,686 filed 15 Feb. 2010, each of which is entitled Assays and Assay Devices, and each of which is incorporated herein by reference in its entirety.

### FIELD OF THE INVENTION

The present invention relates to biological and biochemical assays.

### BACKGROUND OF THE INVENTION

The following discussion is provided solely to assist the understanding of the reader, and does not constitute an admission that any of the information discussed or references cited constitute prior art to the present invention.

Many different types of assays used for detecting biological analytes have been developed and used. In many cases, in order to achieve acceptable precision and accuracy, heterogeneous assays have been used. Such assays involve one or more wash steps to wash away unbound label from bound label. For medical applications, assays of this type are often relatively complex and frequently unsuitable for home use or even point-of-care use, and are thus restricted to laboratory testing. This often prevents results from being available sufficiently quickly to assist in diagnosis and/or treatment selection.

Other assays are commonly referred to as homogeneous assays, which do not require such wash steps. A difficulty in applying homogeneous assays to medical testing is that biological fluids often contain substances that substantially interfere with the analyte binding or signal generation or detection. In some cases, assays are configured to use sample dilution in order to reduce the interference. However, such dilution adds complexity and handling steps, often making such assays unsuitable for home or point-of-care applications.

Further, in attempting to provide reliable point-of-care assays and associated devices, some devices have been constructed to allow assaying using small volumes, i.e., microfluidic devices, and a number of different microfluidic assay devices have been described. For example, Buechler, U.S. Patent Appl. Publ. 2005/0147531 A1 (and related patents) describes “assay device structures for a device where fluid flows from one region to another.” The device structure includes “one or more capillarity-inducing structures; where the capillarity-inducing structure induces capillary force along an axis that is essentially perpendicular to the axis along which capillary force [is] induced in another region of the device.” (Abstract.)

### SUMMARY OF THE INVENTION

This invention concerns an assay platform, including advantageous reagents and a signal detection device advantageous for conducting analyte assays, e.g., biological assays such as protein assays. In many embodiments, the platform can be highly suitable for use in point-of-care applications, or even home monitoring applications, as well as in medical laboratory applications, research laboratory applications, environmental field test applications, and others. The platform can be configured to provide rapid, yet simple, assays with high precision, including configurations for assaying biological fluid samples without requiring the time-consuming wash steps or sample dilution steps required in many current heterogeneous or homogenous assays respectively.

The present platform advantageously uses layered labels and/or uses a novel protein coating method together with a particularly advantageous signal detection device configured to detect time-resolved signals. The combination is specifically designed to attain very low background noise from multiple components of the platform, including labels and detection instrument. Only by jointly reducing background noise can a very quiet platform be achieved, thereby providing very high sensitivity. Using the present low noise component platform, it was discovered highly sensitive assay platforms are provided, which may even be point-of-use assay platforms.

Thus, a first aspect of the invention concerns a method for performing an analyte assay, where the method involves exposing at least one full-coated TRF label to an oscillating exciting illumination, detecting a phosphorescent signal from the label, where the detected signal is indicative of the presence and/or amount of the analyte. The exciting illumination is oscillated at a period less than the decay time of the phosphorescent signal, and the detected signal is averaged over multiple read intervals.

In some embodiments, the method provides detection sensitivity of at least one picomolar or better for analyte in a liquid sample (i.e., detects down to at least one picomolar), e.g., at least 0.7, 0.5, 0.2, 0.1, 0.05, or 0.01 picomolar; the method (or associated assay platform) provides detection sensitivity for analyte in a liquid sample of at least 10, 5, 2, or 1 nanomolar, or at least 500, 200, 100, 50, 20, 10, 5, 2, or 1 picomolar; exciting illumination is ultraviolet (UV) light; a plurality of analytes are detected in a single assay using multiplexing, e.g, as described herein in the Detailed Description; at least 2, 3, 4, 5, 7, or 10 different analytes are detected in a single assay using multiplexing.

In particular embodiments, the method provides a dynamic range covering at least 3, 3.5, 4, 4.5, 5, 5.5, or 6 orders of magnitude of analyte concentration.

In certain embodiments, the oscillating exciting illumination and detecting are carried out as described in Hayes, Internat. Publ. No. WO/2010/01853, Internat. Appl. No. PCT/GB2009/000876, entitled Monitoring Phosphorescence, which is incorporated herein by reference in its entirety. In certain embodiments, the oscillating exciting illumination is carried out as described in Hayes and van Wyk, Internat Appl No. PCT/GB2012/051645, WO/2013/008014, entitled Apparatus and Methods for Use in Measuring a Luminescent Property, which is incorporated herein by reference in its entirety, and/or as described herein, and/or uses signal processing as described therein, or uses an apparatus as described below.

In particular embodiments, the oscillating exciting illumination is provided by one or more light emitting diodes (LED); the oscillating exciting illumination is provided by chopped illumination, e.g., a laser light source; no filtering of illumination is used; no filtering of fluorescent and/or phosphorescent signal is used.

In certain embodiments, the signal is detected in a transmissive configuration; the signal is detected in a reflective configuration; the signal is detected in a combination of transmissive and reflective configuration.

In certain embodiments, the method utilizes an assay cartridge as described in Mpock, Pat Publ US 2009/0117666, application Ser. No. 11/936,258, which is incorporated herein by reference in its entirety; in some cases the assay cartridge is as described in Mpock except it includes a blood separation component upstream of the signal detection zone and/or includes a microchannel detection zone rather than a strip or membrane where signal is detected; within such microchannel detection zone signal is detected in flow and/or single-event binding is detected.

A related aspect concerns an assay platform which includes a particularly advantageous TRF label particle and an advantageous TRF signal detector, and may also include an assay cartridge. The TRF label particle is a full-coated label (e.g., as described herein), and the TRF signal detector incorporates oscillating exciting illumination with an oscillation period less than the decay time of the TRF label signal, and a delayed signal reader. The TRF signal reader may be, or use detection and signal processing, as described in Hayes, Internat. Publ. No. WO/2010/01853, Internat. Appl. No. PCT/GB2009/000876, entitled Monitoring Phosphorescence, or in Hayes, Internat Appl No. PCT/2012/051645, entitled Apparatus and Methods for Use in Measuring a Luminescent Property, each of which is incorporated herein by reference in its entirety, or as otherwise described herein. In some embodiments, the TRF signal reader is an apparatus as described below.

In certain embodiments, the TRF signal detector is configured in a transmissive configuration; the TRF signal detector is configured in a reflective configuration; the TRF signal detector is configured in combination transmissive and reflective configuration.

In particular embodiments, an analyte-specific binding reagent includes or links with a full-coated label, such as a layered label, e.g., a layered label including a plurality of chemiluminescent or fluorescent molecules; the layered label includes a solid phase core, e.g., with chemiluminescent or fluorescent molecules embedded in the solid phase core, attached on the surface of the solid phase core, distributed in the coating layers of the layered label, and/or attached on the surface of the outermost coating layer of the layered label; the layered label does not include a solid phase core; the layered label is as described elsewhere herein for this invention. Likewise in particular embodiments, an analyte-specific binding reagent includes or links with a fully linked coating label, e.g., a reduced disulfide protein coated label.

In certain embodiments, the assay platform includes or utilizes an assay cartridge as described in Mpock, Pat Publ US 2009/0117666, application Ser. No. 11/936,258, which is incorporated herein by reference in its entirety; the assay cartridge is as described in Mpock except it includes a blood separation component upstream of the signal detection zone (e.g., combined with or downsteam of the sample deposition zone) and/or includes a microchannel detection zone rather than a strip or membrane where signal is detected; within such microchannel detection zone signal in flow and/or single-event binding is detected.

In particular embodiments, the platform delivers a dynamic range covering at least 3, 3.5, 4, 4.5, or 5 orders of magnitude of analyte concentration.

Another aspect of the invention concerns a method for detecting the presence or amount or both of an analyte in a solution, and involves binding an analyte-specific binding construct with an analyte in a solution, and detecting a signal from a full-coat label (i.e., a layered label or staged label) linked directly or indirectly with that analyte-specific binding construct, where detection of the signal is indicative of the presence or amount or both of the analyte in the solution.

In some embodiments, the method includes use of a detection device, apparatus, or platform as described herein for the invention, e.g., as described for an aspect above or as described below for an apparatus.

In certain embodiments, the signal is detected in a transmissive configuration; the signal is detected in a reflective configuration.

In particular embodiments, the solution is a biological sample (e.g., undiluted, diluted, or treated), for example blood (diluted or undiluted or treated), plasma (diluted or undiluted or treated), urine, exhaled breath condensate, saliva diluted, undiluted or treated), cerebral spinal fluid (CSF), vaginal fluid, nipple aspirate fluid, male seminal fluid, crude cell extract solution, cell suspension, partially purified cell extract solution; such solutions may be from a mammal, e.g., a human, canine, feline, bovine, porcine, or ovine.

In certain advantageous embodiments, the solution is applied to a lateral flow assay device and the detecting is performed on that device, e.g., a lateral flow device as described herein or as described in any of U.S. Pat. Nos. 6,352,862, 7,238,537, 5,272,785, 5,602,040, 5,656,503, 5,622,871, 6,228,660, 6,156,271, 6,187,598, 7,109,042, 6,818,455, 5,714,389, 6,485,982, 5,989,921, 5,998,221, 5,182,216, 4,956,302, 6,130,100, or in any of U.S. Pat. Nos. 5,798,273, 6,136,610, 6,368,876, 7,132,078, 7,256,053, or 5,766,961 (each of which is incorporated herein be reference in its entirety); the solution is applied to a flow-through assay device and the detecting is performed on that device; the signal is a colorimetric signal, a fluorescent signal which may be a time resolved fluorescent signal (TRF), a bioluminescent signal, a chemiluminescent signal, a radioactive signal.

For particular embodiments, the layered label includes a solid phase core bearing a plurality of detectable signal moieties and at least two (e.g., 2, 3, 4, 5, or even more) linked hydrophilic polymer layers coating the core; the layered label includes at least two (e.g., 2, 3, 4, 5, or even more) linked hydrophilic polymer layers comprising a plurality of detectable signal moieties embedded in the layers; the layered label includes a plurality (e.g., 2, 3, 4, 5, or even more) of linked hydrophilic polymer layers without a solid phase core; the layered label includes a solid phase core and at least two hydrophilic polymer coating layers, wherein the layered label has substantially less non-specific protein binding for proteins in undiluted human plasma than a coated label having the same solid phase core and a single coating of the same hydrophilic polymer as forms the outermost coating layer of the coated polymer.

In other embodiments, the label is a fully linked coating label, e.g., a label particle coated with reduced disulfide protein (such as reduced disulfide bovine serum albumin (BSA)). Such proteins are linked to particles (e.g., beads) under conditions such that at least one type of reactive groups, e.g., amines, are fully, substantially, or predominantly depleted. The beads may include or carry one or more detectable moieties (e.g., colorimetric or fluorescent dyes). The proteins preferably include one or more disulfide bonds, which upon reduction provide —SH groups available for reaction with other moieties. Such other moieties may, for example, be additional protein molecules which may be the same or different, or specific binding moieties, or signal generating moieties.

In particular embodiments, the label is a colorimetric label, a fluorescent label, a luminescent label, a TRF label, or a radioactive label.

A related aspect concerns a full-coat label, such as a layered particulate label which includes a plurality of polymer layers, where at least the outermost of those layers provides low non-specific protein binding, and a plurality of detectable label moieties.

In particular embodiments, the layered label includes 2, 3, 4, or 5 layers (e.g., polymer and/or protein layers) or at least 2, 3, 4, or 5 layers (e.g., polymer and/or protein layers; one or more outer polymer layers are permeable to water; the label includes a solid phase core, which may include a plurality of detectable signal moieties; the label lacks a solid phase core; for either a label with or without a solid phase core the layers, e.g., polymer and/or protein layers, include a plurality of detectable signal moieties; for either a label with or without a solid phase core a plurality of detectable signal moieties are embedded in the polymer and/or protein layers.

In certain embodiments, the label includes a plurality of binding moieties (e.g., avidin or streptavidin) which bind with an analyte-specific binding moiety (e.g., a biotinylated anti-analyte antibody); the label is linked with at least one analyte-specific binding moiety; the label is linked with at least one analyte-specific binding moiety and is linked with at least one analyte; the label is immobilized in a signal detection zone of a lateral flow assay device by linkage with immobilized analyte.

Likewise, in certain embodiments, the full-coat label is a fully linked coating label which includes a solid phase core coated with a highly linked protein coating, preferably substantially maximally linked.

In particular embodiments, the protein coating is BSA; the protein coating is linked to the solid phase surface through naturally occurring amine groups; a protein coating linked to the solid phase surface through amine groups has additional functional groups created by reduction of disulfide bonds in the protein to create —SH groups.

In particular embodiments, the label is a colorimetric label, a fluorescent label, a luminescent label, a TRF label, or a radioactive label.

Another related aspect concerns an assay kit which includes a measured quantity of an analyte-specific binding construct, a full coated label which links directly or indirectly with the analyte-specific binding construct, and at least one lateral flow assay device.

In advantageous embodiments, the assay device is configured to perform a wet assay; a wet assay device is configured to perform field mixing of sample and the first analyte specific binding construct in the device; the assay device is configured to assay a sample of 10 microliters or less; a controlled volume is extracted from a raw sample in the assay device; the mixing is performed using electrowetting effects; the analyte specific binding construct includes a detectable label; the detectable label is a colorimetric label, a fluorescent label, a TRF label, a luminescent label, or a radioactive label.

In certain embodiments of the assays, assay kits, and/or lateral flow assay devices, the sample solution is applied to a lateral flow assay device and the detecting is performed on that device, e.g., a lateral flow device as described herein or as described in any of U.S. Pat. Nos. 6,352,862, 7,238,537, 5,272,785, 5,602,040, 5,656,503, 5,622,871, 6,228,660, 6,156,271, 6,187,598, 7,109,042, 6,818,455, 5,714,389, 6,485,982, 5,989,921, 5,998,221, 5,182,216, 4,956,302, 6,130,100, or in any of U.S. Pat. Nos. 5,798,273, 6,136,610, 6,368,876, 7,132,078, 7,256,053, or 5,766,961 (each of which is incorporated herein be reference in its entirety); the signal is a colorimetric signal, a fluorescent signal, a time resolved fluorescent signal (TRF), a bioluminescent signal, a chemiluminescent signal, a radioactive signal.

Another aspect provides an apparatus for use in measuring a luminescent property of a sample, where the apparatus includes an exciting radiation emitter (such as one or more LEDs), a control signal generator where the control signal modulates an intensity of the emitted radiation. The control signal has a first component at a first frequency having a period that is less than, or of the same order as, an expected characteristic time constant of the luminescent property, and a second component at a second frequency having a period that is greater than the expected characteristic time constant of the luminescent property; a photosensor (also referred to as a photoreceptor or signal detector, which may, for example, be based on photodiodes, bipolar phototransistors, or photoFETs (photo field effect transistors)) which receives radiation luminesced from the sample and generates a detection signal representing an intensity of the received luminesced radiation; and a signal demodulator which demodulates the detection signal and produces a signal representing the luminescent property of the sample (often representing the intensity of the luminescent property).

In certain embodiments, the apparatus for use in measuring a luminescent property of a sample includes a means for emitting radiation to excite the sample, under the control of a control signal), a means for generating the control signal for modulating an intensity of said emitted radiation, where the control signal has a first component at a first frequency having a period that is less than, or of the same order as, an expected characteristic time constant of the luminescent property, and a second component at a second frequency having a period that is greater than the expected characteristic time constant of the luminescent property, a means for receiving radiation luminesced from the sample as a result of the excitation, and for generating a detection signal representing an intensity of the received radiation); and a means for demodulating the detection signal whereby to produce a signal representing the luminescent property of the sample.

In certain embodiments, the luminescent property of the sample is or includes a persistent luminescent property, such as phosphorescent property; an optical filter (e.g., a UV-pass filter) is provided between the radiation emitter and the sample, which optical filter is configured to block radiation having a wavelength associated with the luminescent property to be measured and/or an optical filter is provided between the sample and the photoreceptor, commonly an optical filter configured to block radiation having wavelengths different from the wavelengths associated with the luminescent property to be measured.

A related aspect concerns an apparatus for exciting a sample with radiation, which allows measurement of a luminescent property of the sample. The apparatus includes an exciting radiation emitter under the control of a control signal, a control signal generator where the control signal controls an intensity of emitted radiation from the emitter and the control signal has a first component at a first frequency having a period that is less than, or of the same order as, an expected characteristic time constant of the luminescent property, and a second component at a second frequency having a period that is greater than the expected characteristic time constant of the luminescent property.

In certain embodiments, the apparatus is an apparatus for exciting a sample with radiation whereby to allow measurement of a luminescent property of the sample, where the apparatus includes means for emitting radiation to excite said sample under the control of a control signal, and means for generating a control signal for modulating an intensity of the emitted radiation where the control signal has a first component at a first frequency having a period that is less than, or of the same order as, an expected characteristic time constant of the luminescent property and a second component at a second frequency having a period that is greater than the expected characteristic time constant of the luminescent property.

In some embodiments of the above two aspects, the first component of the control signal is derived from a first periodic signal; the first periodic signal oscillates between at least two different voltage levels, e.g., where a lower magnitude one of the voltage levels is a substantially zero (or near zero) voltage level; the second component of the control signal is derived from a second periodic signal; the first and second periodic signals are such that the control signal causes the radiation emitting means to switch between an ‘ON’ state in which it emits light and an ‘OFF’ state in which it does not emit light at a frequency approximately equal to a frequency of the first periodic signal; the second component of the control signal is derived from a second periodic signal; the second periodic signal oscillates between at least two different voltage levels; the second periodic signal is a sinusoidal signal; one of the voltage levels of the second periodic signal is a substantially zero (or near zero) voltage level; the second periodic signal is offset such that the signal remains at the same polarity throughout its cycle; the second periodic signal is offset such that the minimum magnitude of the signal is non-zero; the radiation emitter is or includes a light emitting diode, e.g., a light emitting diode which is operable to emit radiation in ultra violet region.

Likewise in some embodiments of the above two aspects, the control signal generator is operable to adjust the frequency (or period) of the first component and/or the second component.

In embodiments in which a control frequency is adjustable, the control signal generator is operable to adjust the frequency of the first component between a plurality of different frequencies where the first frequency has a period that is less than, or of the same order as, an expected characteristic time constant of the luminescent property of the sample; and/or at least one further frequency has a period that is less than, or of the same order as, a further expected characteristic time constant of the luminescent property of the sample or an expected characteristic time constant of a further sample, whereby to allow discrimination between components of the sample having different luminescent properties and/or discrimination between different samples having different luminescent properties; the control signal generator (e.g., the means for generating a control signal) is operable to cycle through each of a plurality of different frequencies in turn.

A related aspect concerns an apparatus for detecting radiation luminesced from a sample, where the apparatus includes a signal detector which detects radiation emitted from the sample as a result of excitating radiation from the radiation source, a detection signal generator which generates a detection signal representing an intensity of the radiation emitted from the sample, and a signal demodulator. The exciting radiation from the radiation source is modulated by a control signal having a first component at a first frequency having a period that is less than, or of the same order as, an expected characteristic time constant of a luminescent property of the radiation emitted from the sample, and a second component at a second frequency having a period which is greater than the expected characteristic time constant of the luminescent property. The signal demodulator demodulates the detection signal, producing a signal representing the luminescent property of the sample.

In certain embodiments, the apparatus is an apparatus for detecting radiation luminesced from a sample whereby to allow measurement of a luminescent property of the sample, including means for receiving radiation luminesced from the sample as a result of excitation of the sample with radiation from a radiation source and means for generating a detection signal representing an intensity of the received radiation, wherein the said radiation from the radiation source is modulated by a control signal having a first component at a first frequency having a period that is less than, or of the same order as, an expected characteristic time constant of the luminescent property, and a second component at a second frequency having a period which is greater than the expected characteristic time constant of the luminescent property, and means for demodulating said detection signal whereby to produce a signal representing said luminescent property of said sample.

In embodiments of the apparatus described herein, the demodulator (e.g., demodulating means) can include a first demodulation arrangement for demodulating a first frequency component of the detection signal, which first frequency component is associated with the first component of the control signal, and a second demodulation arrangement for demodulating a second frequency component of the detection signal, which second frequency component is associated with the second component of the control signal, e.g., where the first demodulation arrangement is operable to suppress a first component of the detection signal arising when the sample is being excited (for example, where the first component of the detection signal arises, at least in part, from fluorescence or short time-constant phosphorescence from the sample), and/or the first demodulation arrangement is operable not to suppress a second component of the detection signal arising when the sample is not being excited, e.g., where the second component of the detection signal arises, at least in part, from phosphorescence from the sample.

In certain embodiments concerning the first demodulation arrangement, the first demodulation arrangement includes a switched demodulator arrangement arranged to switch the detection signal on and off whereby to demodulate the signal; the first demodulation arrangement includes a gain switch which switches the detections signal generator between high and low gain levels (e.g., a means for switching the gain of the generating means between a high gain and a low gain) whereby to demodulate the signal; the first demodulation arrangement also includes a filter (e.g., a low pass filter) for filtering out any remaining components at the first frequency from the detection signal.

In certain embodiments having first and second demodulation arrangements, the second demodulation arrangement is operable to demodulate the second frequency component of the detection signal as demodulated by the first demodulation arrangement; the signal demodulator includes an amplifier for amplifying the detection signal as demodulated by the first demodulation arrangement, e.g., where the second demodulation arrangement is operable to demodulate the second frequency component of the detection signal as demodulated by the first demodulation arrangement and amplified by the amplifier. In some cases, the amplifier is or includes a large gain (and/or ac coupled) amplifier; the second demodulation arrangement includes a multiplier (e.g. a mixer) for multiplying the detection signal with a signal having a frequency substantially equal to that of the second frequency component; the second demodulation arrangement includes an envelope detector operable to suppress the second frequency component of the detection signal; the second demodulation arrangement includes a filter for filtering out any remaining components at the second frequency from the detection signal (e.g, a low-pass filter).

Another aspect provides a method of generating a signal representing a luminescent property of a sample for use in measuring the luminescent property of the sample, where the method includes generating a control signal having a first component at a first frequency having a period that is less than, or of the same order as, an expected characteristic time constant of the luminescent property, and a second component at a second frequency having a period that is greater than the expected characteristic time constant of the luminescent property; emitting radiation to excite the sample, under the control of the control signal, such that the emitted radiation is modulated by the control signal; receiving radiation luminesced from the sample as a result of the excitation, and generating a detection signal representing an intensity of the received radiation; and demodulating the detection signal whereby to produce a signal representing the luminescent property of the sample.

A further aspect concerns a method of exciting a sample with radiation whereby to allow measurement of a luminescent property of the sample. The method includes generating a control signal having a first component at a first frequency having a period that is less than, or of the same order as, an expected characteristic time constant of the luminescent property, and a second component at a second frequency having a period that is greater than the expected characteristic time constant of the luminescent property; and emitting radiation to excite the sample, under the control of the control signal, such that the emitted radiation is modulated by the control signal.

Yet another aspect concerns a method of generating a signal representing a luminescent property of a sample for use in measuring the luminescent property of the sample. The method includes receiving radiation luminesced from the sample as a result of excitation of the sample with radiation from a radiation source and generating a detection signal representing an intensity of the received radiation, wherein the radiation from the radiation source is modulated by a control signal having a first component at a first frequency having a period that is less than, or of the same order as, an expected characteristic time constant of the luminescent property, and a second component at a second frequency having a period which is greater than the expected characteristic time constant of the luminescent property; and demodulating the detection signal whereby to produce a signal representing the luminescent property of the sample.

In some particularly useful embodiments of aspects concerning the apparatus described above and otherwise described herein, the signal representing the luminescent property of the sample represents the level (or inverse thereof) of one or more intended analytes in the sample.

Additional embodiments will be apparent from the Detailed Description and from the claims.

### BRIEF DESCRIPTION OF THE DRAWINGS

FIG. 1 shows a simplified overview of measurement apparatus for measuring phosphorescent properties of a sample;

FIG. 2 shows a simplified circuit schematic illustrating key components of the measurement apparatus of FIG. 1;

FIGS. 3a to 3d and 4a to 4c show simplified and idealised illustrations of electronic/light waveforms that may be observed at different parts of the circuit of FIG. 2;

FIG. 5 shows a simplified circuit schematic illustrating photoemitter drive circuitry for an embodiment of the invention; and

FIGS. 6a and 6b show a simplified circuit schematic illustrating photoreceiver circuitry for an embodiment of the invention.

### DETAILED DESCRIPTION OF THE PREFERRED EMBODIMENTS

### A. Introduction

Many different assays have been developed for qualitative, semi-quantitative, or quantitative detection of the present of particular analytes, especially in solutions. In many cases, the analytes are present in biological samples, such as blood, serum, urine, and the like. This invention concerns an advantageous assay platform and associated reagents and methods.

### B. Assay Platform and Methods

In many cases, it is beneficial to provide an assay platform which is particularly suited to a set of reagents. In this case, it has been found that full-coated reagents are highly useful, e.g., in reducing background signal. The platform can also include an instrument for detecting the assay signal(s). The TRF signal reader may, for example, be as described in Hayes, Internat. Publ. No. WO/2010/01853, Internat. Appl. No. PCT/GB2009/000876, entitled Monitoring Phosphorescence, or Hayes and van Wyk, Internat Appl No. PCT/GB2012/051645, entitled Apparatus and Methods for Use in Measuring a Luminescent Property, each of which is incorporated herein by reference in its entirety. In particular, apparatus and methods according to Hayes and van Wyk are described below.

In some applications, this invention uses a method and corresponding instrument for the excitation and detection of long-lived fluorescent and phosphorescent dyes, this detection scheme is called time resolved fluorimetry (TRF). According to this method, a dye or dye complex, such as a chelated lanthanide metal, with a long radiative lifetime is attached, directly or indirectly, to the molecule of interest. Pulsed excitation (i.e., illumination with light of an appropriate wavelength) combined with a gated detection system allows for effective discrimination against short-lived background emission. The long-lived phosphorescence avoids background fluorescence by use of an intermittent excitation source and a timed coupled measurement of phosphorescent emission.

The lanthanide metals used for such labels include terbium, dysprosium, europium, neodymium, and samarium chelates, with terbium and europium being used most often. While chelated lanthanide metals are currently most commonly used for TRF labels, other types of labels can also be used, such as some metalloporphyrins, e.g., palladium, platinum, and lutetium metalloporphyrins. Such materials provide phosphoresce with high quantum yields at room temperatures. Zinc, aluminum, yttrium, and tin metalloporphyrins also manifest delayed fluorescence and may be used in some applications. There are three main classes of metalloporphyrins used for these applications, those being drivatives of porphyrin, tetraphenylporphyrin, and tetraphenyl-(tetrabenzo)-porphyrin). For example—palladium coproporphyrin (PdCP) has a lifetime of more than 900 microseconds.

A method of monitoring phosphorescence emitted by a TRF assay label involves exposing the label to stimulating radiation to generate a phosphorescent response from the label. In some applications of the present method and platform, the amplitude of the stimulating radiation oscillates between higher and lower magnitudes. The emitted phosphorescence is detected. The stimulating radiation is oscillated at a frequency with a period less than the decay time of the phosphorescence.

In another alternative to detect fluorescence, where both fluorescence and phosphorescence are emitted from a TRF label, the method involves detecting radiation emitted from the label; and averaging the sum of i) the detected radiation when the stimulated radiation is at the higher amplitude, and ii) the inverse of the detected radiation when the stimulated radiation is at is lower or zero amplitude. Preferably, the method is carried out at a plurality of locations on the assay strip. This can be achieved by causing relative motion between the source and the strip or by using respective pairs of sources and detectors.

The principle on which the known method and apparatus operate is that fluorescence turns on and off essentially simultaneously with exposure to the source of stimulating radiation, while phosphorescence has a significantly longer decay time which means that when not exposed to the stimulating radiation, the phosphorescent signal remains on and gradually decays. Thus, when a feature on an item, such as an assay strip, which generates both fluorescence and phosphorescence is activated, it will generate a signal with both fluorescent and phosphorescent components but when the activating radiation is not present, it will only emit phosphorescence. Suitable processing electronics can then be used to detect the phosphorescent signal (in the absence of the fluorescent signal)

The test or assay strip can be passed between the stimulating radiation source, e.g., LED, and the photodetector by a 1-D scanning stage, driven by a small stepper motor. This means that the strip is scanned. Depending on the properties of the strip, the radiation source and the detector may be on the same side of the strip and operate in reflection mode, or on opposite sides of the strip and operate in transmission mode.

The reader can be optimized for sensitivity by extensively tuning one or more of several parameters, e.g., as listed below:
The key electronic drive parameters affecting sensitivity include gain, illuminate-detect delay time, LED chopping frequency, LED modulation frequency and amplitude.
Physical alignment of LED, stage and detector, and stage translation speed.
The use of short-pass filters on the LED and long pass filters on the detector could be used, but optimum configuration can be achieved without the use of filters.
a small stepper motor was used to drive the stage and therefore scan the assay strip.

The reader identified above can be used in a method of monitoring phosphorescence emitted by TRF label involving exposing the label to stimulating radiation, to generate a phosphorescent response, the amplitude of the stimulating radiation oscillating between higher and lower magnitudes; and detecting the emitted phosphorescence characterized in that the stimulating radiation is oscillated at a frequency with a period less than the decay time of the phosphorescence.

Thus, the above reader or apparatus for monitoring phosphorescence emitted from TRF label includes a source of stimulating radiation for generating a phosphorescence response, the stimulating radiation regularly oscillating between higher and lower amplitudes; a detector for detecting the phosphorescent response and generating a suitable output signal; and a processing system for determining the phosphorescence from the output signal from the detector characterized in that the source is adapted to cause the stimulating radiation to oscillate at a frequency with a period less than the decay time of the phosphorescence.

As indicated, it is possible to monitor phosphorescence, particularly emitted together with fluorescence, when the stimulating radiation is oscillated at a frequency with a period less than the decay time of the phosphorescence. Because the source flashes so quickly by comparison to the time in which the phosphor can respond, the component of the received signal due to the phosphorescence behaves as if the source were always on; this creates a slow offset (baseline) for the received signal. Although the phosphor responds as if the source were always on, the faster-responding fluorescence (i.e., prompt fluorescence) does respond almost immediately to the fast modulation, and so the received signal also has a fast component that changes between two time periods; when the source is on the signal is due to both fluorescence and phosphorescence, but when the source is off the signal returns to the baseline and is therefore only due to the phosphorescence. It is therefore possible to isolate the phosphorescence signal very simply, for example by averaging the received signal during the periods when the source is off.

The device also enables LED sources to be used because of the inherent switching speed and stability of LEDs and the ability precisely to control the “on” time overcomes their limited output power. As an alternative to LEDs, a UV tube or the like could be used in the device, the tube being maintained on at all times with a shutter being provided to sequentially pass or not pass the stimulating UV radiation.

Although a single LED can be used in the device, two or more LEDs can be used. The LEDs effectively “pre-charge” the luminescent feature on the article (e.g, assay strip) in a similar way to a continuous light source and particularly where the article is transported past the source, the motion of the article is used to enable multiple LEDs to act as if they were one bright LED. Even though there may be a small amount of decay in the phosphorescent signal, this avoids the difficult and inefficient focussing of LED sources to create a high-intensity spot. The fast modulation approach also supports resolution of small features at higher transport speeds.

An additional advantage of the arrangement is that it reduces the dynamic range requirement of the optical detector (the ratio of the maximum signal to the minimum signal) because the large fluorescence signal only depends upon the intensity within the detection area. The detector can be tuned to look purely for the signal given off by the phosphor (when the source is switched off) rather than trying to deal with the much brighter signal given off by the fluorescence as well.

Typically, the lower magnitude of the amplitude is zero although in some cases it could be non-zero providing fluorescence is not stimulated at that level. Typically, the stimulating radiation will have a square wave amplitude variation although other forms such as sinusoidal are also possible. In many cases, the phosphorescence and luminescence signals will be at the same wavelength.

The stimulating radiation typically comprises UV light although other stimulating wavelengths can be used depending upon the nature of the feature to be stimulated. Examples include a wavelength centered on about 365 nm (300-400 nm).

Among other things, the invention thus involves a method of monitoring phosphorescence emitted by TRF label in an assay (and the corresponding assay method). The method includes exposing the label to stimulating radiation to generate a phosphorescent response. The amplitude or intensity of the stimulating radiation oscillates between higher and lower magnitudes (often zero or substantially zero intensity); and detecting the emitted phosphorescence. The stimulating radiation is oscillated at a frequency with a period less than the decay time of the phosphorescence.

The assay label is often directly or indirectly attached to a binding molecule, e.g. an analyte-binding molecule. The label has a long radiative lifetime compared to prompt fluorescence. For example, the label may be a chelated lanthanide metal. The stimulating radiation is selected to be appropriate for the particular label. In many cases, the stimulating radiation is UV light.

In many cases, detecting the phosphorescent response involves detecting radiation emitted from the TRF label and averaging the radiation detected when the stimulating radiation is at its lower or zero amplitude. In some applications, the method involves detecting the fluorescent response emitted from the TRF label by detecting radiation emitted from the label; and averaging the radiation detected when the stimulated radiation is at its higher amplitude. Further, in some cases, the method involves detecting fluorescence emitted from TRF label in a mixture of phosphorescence and fluorescence, and involves averaging the sum of i) the detected radiation when the stimulated radiation is at the higher amplitude, and ii) the inverse of the detected radiation when the stimulated radiation is at is lower or zero amplitude.

In many applications, the TRF signal is indicative of analyte concentration, though it may alternatively be used as an indicator of the presence of an analyte (i.e., presence or absence of an analyte).

In some applications, the method also involves causing relative movement between the stimulating radiation and location of the label so as to expose the plurality of locations on an item (e.g, an assay strip) to the stimulating radiation. This can be used, for example, for assay multiplexing. In addition or alternatively, the method can involve carrying out the stimulation and detection at a plurality of locations (e.g., different locations on an assay strip) simultaneously or substantially simultaneously using respective pairs of stimulating radiation sources and detectors.

As indicated above, multiplexing may beneficially be used in some applications. For example, multiplexing can be accomplished using multiple labels may be used (e.g., different lanthanide chelates), where each gives a different emission phosphorescence and/or fluorescence time signal. The different temporal characteristics of the different labels allows them to be distinguished, thereby distinguishing different corresponding analytes. Labels may, for example be selected from chelates of different lanthanide metals, e.g, terbium, samarium, europium, dysprosium, or neodymium chelates with different decay times. Additional multiplexing techniques useful in the present invention are discussed below.

### C. Signal Processing and Apparatus

As mentioned above, the invention includes methods and apparatus as described in Hayes and van Wyk, PCT/GB2012/051645, which is incorporated herein by reference in its entirety. Likewise, the present assay platform can advantageously include an assay instrument or apparatus which incorporates the techniques described therein.

As described, the methods involve measuring a luminescent property of a sample, and particularly measuring a time resolved luminescent property, such as phosphorescence. The invention has particular benefits in, but is not limited to, the measurement of phosphorescent (time-resolved fluorescence/luminescence) properties of samples used in biological assays or the like.

It is known to use biological assays in which optical characteristics of a sample are modified by the presence of an analyte. The change in the optical properties can then be detected by an appropriately calibrated reader. Commonly, for example, a change in colour or absorption properties of the sample occurs in the presence of the analyte. Whilst such changes are relatively straightforward to measure they can lack the required sensitivity. Greater sensitivity may be achieved using assays in which the change in optical properties may be detectable as a change in phosphorescent properties of the sample because the phosphorescence may be distinguished from other optical effects by its temporal characteristics.

The measurement of phosphorescence may be achieved by intermittent optical excitation at one wavelength (for example in the ultra-violet region) and subsequent measurement of the decaying luminescence signal at another wavelength (usually in the visible region). In this way phosphorescence, which has a relatively long decay time (typically anywhere in the region of micro-seconds to seconds), may be distinguished from any fluorescence, which has a relatively short decay time (e.g. typically less than 1 micro-second). However, this requires precise synchronisation between the illumination of the sample and the detection of the resulting luminescence within the reader. Moreover, the intensity of the phosphorescence may be several orders of magnitude less than the intensity measured by absorption-change readers, complicating the electronic design significantly. These practical difficulties have limited the applicability of phosphorescence-inducing assays in the increasing number of applications that require a low-cost reader. Examples include point-of-care and home diagnostic devices based on luminescent immunoassays. These include, amongst others, products to detect cardiovascular conditions and a range of infectious diseases.

Accordingly, the present invention seeks to provide apparatus and associated methods for use in measuring a luminescent property of a sample that overcome or at least partially mitigate the above problems.

According to one aspect of the present invention there is provided apparatus for use in measuring a luminescent property of a sample, the apparatus comprising: an excitation light source for emitting radiation to excite said sample, under the control of a control signal; a signal source for generating said control signal for modulating an intensity of said emitted radiation, said control signal having a first component at a first frequency having a period that is less than, or of the same order as, an expected characteristic time constant of said luminescent property, and a second component at a second frequency having a period that is greater than said expected characteristic time constant of said luminescent property; a photodetector for receiving radiation luminesced from said sample as a result of said excitation, and for generating a detection signal representing an intensity of said received radiation; and a demodulator for demodulating said detection signal whereby to produce a signal representing said luminescent property of said sample.

The luminescent property of the sample may comprise a photoluminescent property of the sample, for example a persistent luminescent property such as a phosphorescent property or the like. The characteristic time constant may be a decay time constant.

The optical filter may be provided between the radiation emitting means and the sample (and/or between the radiation receiving means and the sample), which optical filter may be configured to block radiation having a wavelength associated with the luminescent property to be measured. The optical filter may comprise a UV-pass filter or any other suitable filter.

The radiation may comprise ultraviolet radiation having a wavelength of around 365 nm, or around 265 nm. The radiation may, however, comprise ultraviolet radiation having a wavelength anywhere in the range of about 400 nm down to about 10 nm (energies of about 3 eV to about 124 eV). The radiation may, for example be radiation in a ‘near’ UV spectral region having a wavelength of between about 400 nm and about 300 nm (˜3.10 eV to ˜4.13 eV), in a ‘middle’ UV region having a wavelength of between about 300 nm and about 200 nm (˜4.13 eV to ˜6.20 eV), in a ‘far’ UV region having a wavelength of between about 200 nm and about 122 nm (˜6.20 eV to ˜10.2 eV), and/or in a in a ‘extreme’ UV region having a wavelength of between about 121 nm and about 10 nm (˜10.2 eV to ˜124 eV). The radiation may, for example, be UVA radiation having a wavelength of between about 400 nm and about 315 nm (˜3.10 eV to ˜3.94 eV), UVB radiation having a wavelength of between about 300 nm and about 280 nm (˜3.94 eV to ˜4.43 eV), UVC radiation having a wavelength of between about 280 nm and about 100 nm (˜4.43 eV to ˜12.4 eV), and/or Vacuum UV (‘VUV’) radiation having a wavelength of between about 200 nm and about 10 nm (˜6.2 eV to ˜124 eV).

According to another aspect of the present invention there is provided apparatus for exciting a sample with radiation whereby to allow measurement of a luminescent property of the sample, the apparatus comprising: an excitation light source for emitting radiation to excite said sample under the control of a control signal; and a signal source for generating a control signal for modulating an intensity of said emitted radiation, said control signal having a first component at a first frequency having a period that is less than, or of the same order as, an expected characteristic time constant of said luminescent property, and a second component at a second frequency having a period that is greater than said expected characteristic time constant of said luminescent property.

The radiation emitting means may have a threshold voltage such that when said control signal exceeds the threshold voltage the radiation emitting means is in an ‘ON’ state in which it emits radiation, and when the control signal does not exceed said threshold voltage the radiation emitting means is in an ‘OFF’ state in which it does not emit radiation.

The first component of said control signal may be derived from a first periodic signal. The first periodic signal may oscillate between at least two different discrete voltage levels. In some implementations, a lower magnitude one of said voltage levels of said first periodic signal may have a magnitude below approximately 1V and may be a substantially zero (or near zero) voltage level. The second component of the control signal may be derived from a second periodic signal.

The first and second periodic signals may be such that said control signal may cause the radiation emitting means to switch between an ‘ON’ state in which it emits light and an ‘OFF’ state in which it does not emit light at a frequency approximately equal to a frequency of said first periodic signal. It will be appreciated, however, that whilst the switching frequency may be substantially equal to that at which the radiation emitting means switches it need not be exactly equal to that of the first periodic signal. For example, the switching frequency may be a function of both the ‘fast’ first periodic frequency ‘f_{fast}’ signal and the ‘slow’ second periodic signal frequency ‘f_{slow}’. In the case of fast and slow sinusoidal periodic signals, for example, the radiation emitting means will switch at a frequency having components at the frequencies f_{fast}±f_{slow}.

The second periodic signal may be a sinusoidal signal. The second periodic signal may oscillate between at least two different discrete voltage levels. The second periodic signal may be offset such that the signal remains at the same polarity throughout its cycle, which offset may be such that the minimum magnitude of the signal is non-zero.

In some implementations, where the second periodic signal comprises a plurality of discrete voltage levels, one of the voltage levels of said second periodic signal (e.g. a minimum magnitude level) may have a magnitude below approximately 1V, for example a substantially zero (or near zero) voltage level.

The radiation emitting means may comprise a light emitting diode, for example a light emitting diode that is operable to emit radiation in ultra violet region.

According to another aspect of the present invention there is provided apparatus for detecting radiation luminesced from a sample whereby to allow measurement of a luminescent property of the sample, the apparatus comprising: a photodetector for receiving radiation luminesced from said sample as a result of excitation of said sample with radiation from a radiation source, and for generating a detection signal representing an intensity of said received radiation, wherein: said radiation from said radiation source is modulated by a control signal having a first component at a first frequency having a period that is less than, or of the same order as an expected characteristic time constant of said luminescent property, and a second component at a second frequency having a period which is greater than the expected characteristic time constant of said luminescent property; and a demodulator for demodulating said detection signal whereby to produce a signal representing said luminescent property of said sample.

The demodulator may comprise a first (e.g. ‘fast’) demodulation arrangement for demodulating a first (e.g. ‘high’) frequency component of said detection signal, which first frequency component may be associated with said first component of the control signal. The demodulator may comprise a second (e.g. ‘slow’) demodulation arrangement for demodulating a second (e.g. ‘low’) frequency component of said detection signal, which second frequency component may be associated with said second component of the control signal.

The first demodulation arrangement may be operable to suppress (e.g. inhibit or ‘switch out’) a first component of said detection signal arising when said sample is being excited (e.g. when the radiation source is in an ‘ON’ state/emitting radiation). The first component of said detection signal may arise, at least in part, from fluorescence from said sample. The first component of said detection signal may arise, at least in part, from short time-constant phosphorescence.

The first demodulation arrangement may be operable not to suppress, inhibit, or switch out, a second component of said detection signal which may arise when said sample is not being excited (e.g. when the radiation source is in an ‘OFF’ state/not emitting radiation). The second component of the detection signal may arise, at least in part, from persistent luminescence (e.g. phosphorescence) from said sample.

The first demodulation arrangement may comprise a switched demodulator arrangement arranged to switch said detection signal ‘on’ and ‘off’ whereby to demodulate said signal. The first demodulation arrangement may comprise means for switching the gain of the generating means between a high gain and a low gain whereby to demodulate said signal. The first demodulation arrangement may further comprise a filter for filtering out a remaining component at the first frequency from the detection signal. The filter comprises a low-pass filter.

The second demodulation arrangement may be operable to demodulate the second frequency component of the detection signal as demodulated by said first demodulation arrangement (e.g. a version of the detection signal that has been demodulated to suppress the first frequency component(s)).

The demodulating means may further comprise an amplifier for amplifying the detection signal as demodulated by said first demodulation arrangement. The second demodulation arrangement may be operable to demodulate the second frequency component of the detection signal as demodulated by said first demodulation arrangement and/or as amplified by said amplifier. The amplifier may comprise a large gain (and/or ac coupled) amplifier.

The second demodulation arrangement may comprise a multiplier (e.g. a mixer) for multiplying the detection signal with a signal having a frequency substantially equal to that of the second frequency component. The second demodulation arrangement may comprise an envelope detector operable to suppress the second frequency component of the detection signal. The second demodulation arrangement may comprise a filter for filtering out a remaining component at the second frequency from the detection signal. The filter for filtering out the remaining component at the second frequency may comprise a low-pass filter.

Where the detection signal is mentioned herein, it will be appreciated that the detection signal referred to may be the detection signal as detected (e.g. prior to an demodulation/filtering/amplification or the like) or as processed or partially processed by a demodulator, filter, amplifier and/or the like

According to another aspect of the present invention there is provided a method of for generating a signal representing a luminescent property of a sample for use in measuring said luminescent property of the sample, the method comprising: generating a control signal having a first component at a first frequency having a period that is less than, or of the same order as, an expected characteristic time constant of said luminescent property, and a second component at a second frequency having a period that is greater than said expected characteristic time constant of said luminescent property; emitting radiation to excite said sample, under the control of said control signal, such that said emitted radiation is modulated by the control signal; receiving radiation luminesced from said sample as a result of said excitation, and generating a detection signal representing an intensity of said received radiation; and demodulating said detection signal whereby to produce a signal representing said luminescent property of said sample.

According to another aspect of the present invention there is provided a method of exciting a sample with radiation whereby to allow measurement of a luminescent property of the sample, the method comprising: generating a control signal having a first component at a first frequency having a period that is less than, or of the same order as, an expected characteristic time constant of said luminescent property, and a second component at a second frequency having a period that is greater than said expected characteristic time constant of said luminescent property; and emitting radiation to excite said sample, under the control of said control signal, such that said emitted radiation is modulated by the control signal.

According to another aspect of the present invention there is provided a method of generating a signal representing a luminescent property of a sample for use in measuring said luminescent property of the sample, the method comprising: receiving radiation luminesced from said sample as a result of excitation of said sample with radiation from a radiation source and generating a detection signal representing an intensity of said received radiation, wherein: said radiation from said radiation source is modulated by a control signal having a first component at a first frequency having a period that is less than, or of the same order as, an expected characteristic time constant of said luminescent property, and a second component at a second frequency having a period which is greater than the expected characteristic time constant of said luminescent property; and demodulating said detection signal whereby to produce a signal representing said luminescent property of said sample.

In one embodiment of the invention, there is provided a detector for the measurement of the phosphorescence of a sample. The detector comprises: an ultra-violet LED suitable for optical excitation, an electronic circuit that is able to modulate the brightness of the LED in response to a control signal, a controller that generates a modulating signal that is the product of two oscillations, one fast (or possibly of the same order) and one slow relative to the phosphorescence decay time, a photodiode detector that measures the brightness of the luminescence, and a processor that demodulates the detector signal with respect to first high and then low frequency control signals, resulting in an output that depends only upon the phosphorescence of the sample.

This detector has the potential to overcome or at least mitigate problems with the known detectors. Firstly, the use of fast modulation of the source helps to ensure that the intensity of the phosphorescence is maximised. Secondly, the use of a second slow modulation helps to simplify the electronic circuitry required to measure the signal associated with phosphorescence even when it is relatively small. Thirdly, the dual-modulation approach can help to enable a measurement of phosphorescence to be made independently of background and other parasitic effects such as ambient lighting, photodiode leakage and/or amplifier offsets.

The fast component of the modulation signal may oscillate between two levels, one of which may be zero or near-zero. Advantageously, this has the potential to simplify isolation of the phosphorescence information, typically with a switched demodulator.

The slow modulation signal may be sinusoidal in nature and is demodulated with a linear multiplier. Advantageously, this has the potential to enable high sensitivity without excessively long measurement times.

The slow component of the modulation signal may oscillate between two levels, one of which may be zero or near-zero. Advantageously this has the potential to allow a simplified switched demodulation to be used when the required measurement bandwidth is low.

The slow modulation frequency may advantageously be selected so as to be distinct from dynamic sources of interfering light, for example, interfering light such as can be produced by incandescent bulbs or fluorescent tubes, thereby providing the potential to minimise sensitivity of the apparatus to ambient light.

This invention will now be described by way of example only with reference to the attached figures.

### Overview

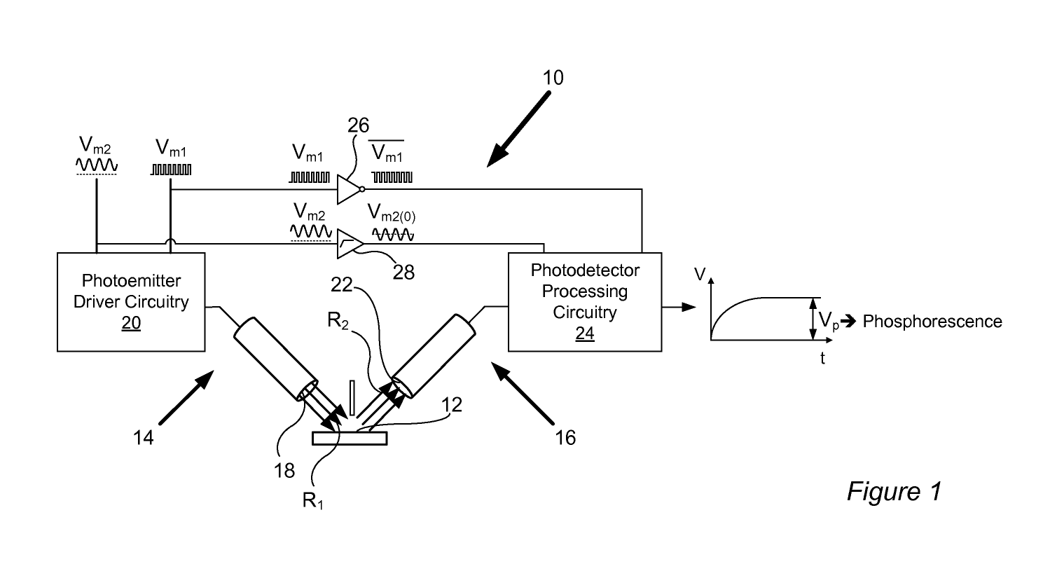

FIG. 1 shows a simplified overview of measurement apparatus 10 for measuring phosphorescent (time-resolved fluorescence/luminescence) properties of a sample 12.

As seen in FIG. 1 the measurement apparatus 10 comprises photo-emitter apparatus 14 for exciting the sample 12 with radiation of a desired wavelength, and photodetector apparatus 16 for detecting photoluminescence arising as a result of the excitation.

The photo-emitter apparatus 14 comprises a radiation emitting device 18 for emitting radiation R₁ to excite the sample 12. In this embodiment the radiation emitting device 18 comprises a light emitting diode (‘LED’) that emits light in the ultraviolet (‘UV’) region.

The UV LED 18 is driven by driver circuitry 20 that is arranged to modulate the intensity of the radiation emitted by the LED 18. The driver circuitry 20 receives a high frequency input signal (Vₘ₁) and a low frequency input signal (Vₘ₂), which the circuitry 20 multiplies together to generate a control signal for controlling the intensity of the UV radiation emitted by the LED 18.

The photodetector apparatus 16 comprises a radiation receiving device 22 arranged to receive radiation R₂ from the sample 12 and to generate a signal representing the received radiation. In this embodiment, the radiation receiving device 22 comprises a photodiode in the form of a P-type/intrinsic/N-type (PiN) diode. The received radiation of this embodiment is in the visible spectral region and typically comprises a plurality of components including, for example, light that is luminesced by the sample 12 as a result of the excitation by radiation from the LED 18 (e.g. fluorescence and/or phosphorescence), light reflected by the sample 12, and/or background/ambient (parasitic) light.

The signal representing the radiation received by the photodiode 22 is processed by photodetector processing circuitry 24. The photodetector processing circuitry 24 demodulates the signal representing the received radiation using an inverted version ( V̅ₘ₁) of the high frequency input Vₘ₁ (produced by an inverter 26) and a zero centred version (Vₘ₂₍₀₎) of the low frequency input Vₘ₂ (produced by a high pass filter 28), to remove components of the signal associated with fluorescence, reflection and background/ambient light. Thus, as will be described in more detail below, the photodetector processing circuitry 24 extracts a signal ‘V_{P}’ representing the magnitude of the phosphorescent component of the light received by the photodiode 22, excluding components of the received light associated with fluorescence, reflection and background/ambient light.

### Exemplary Circuit Implementation

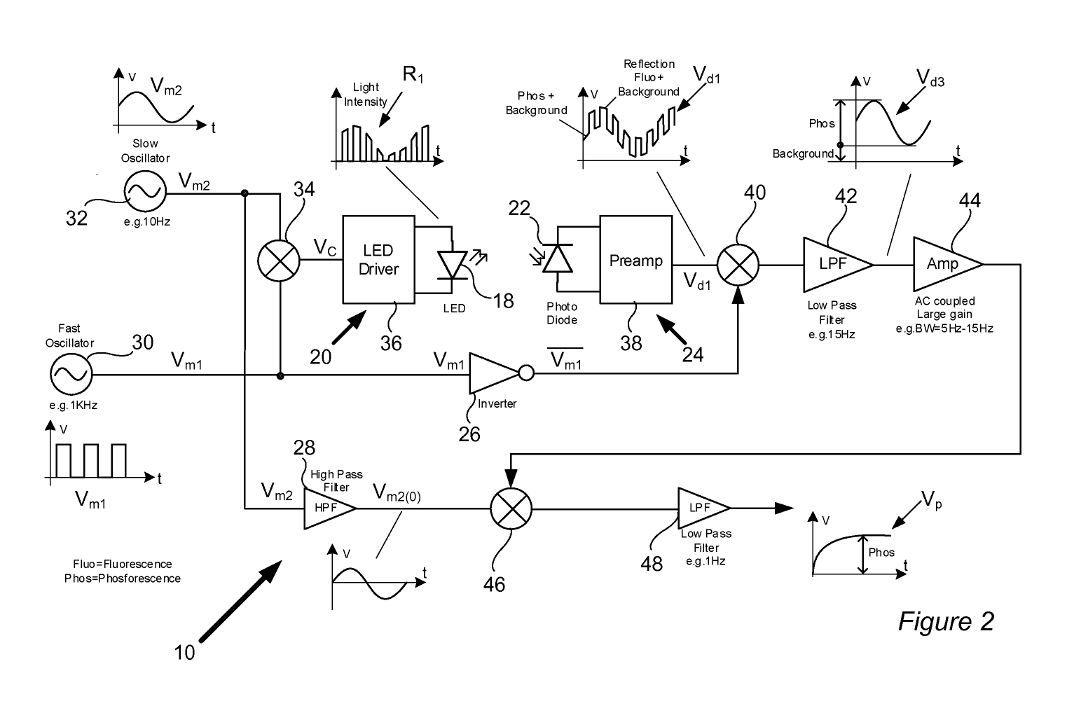

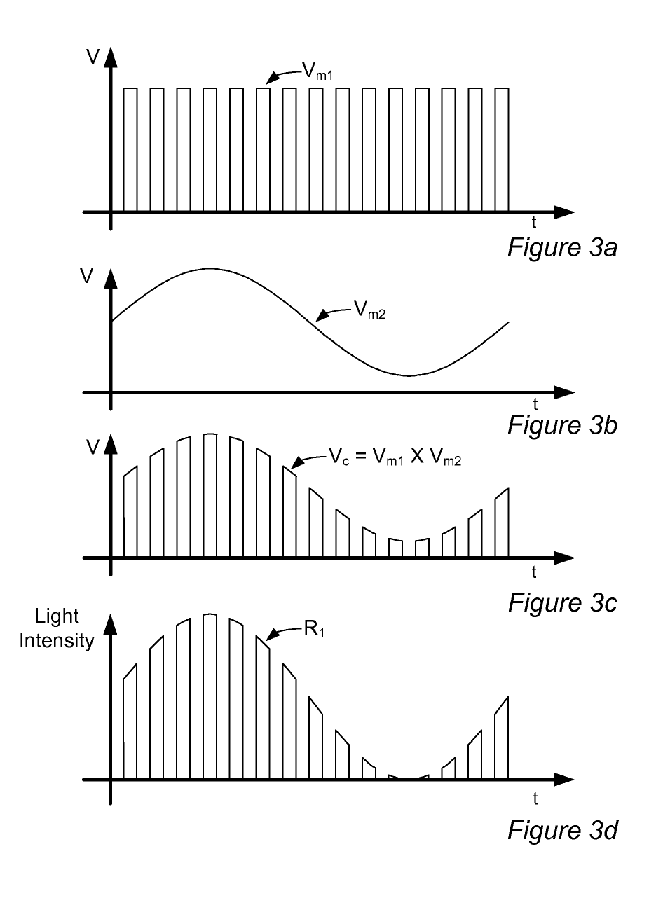

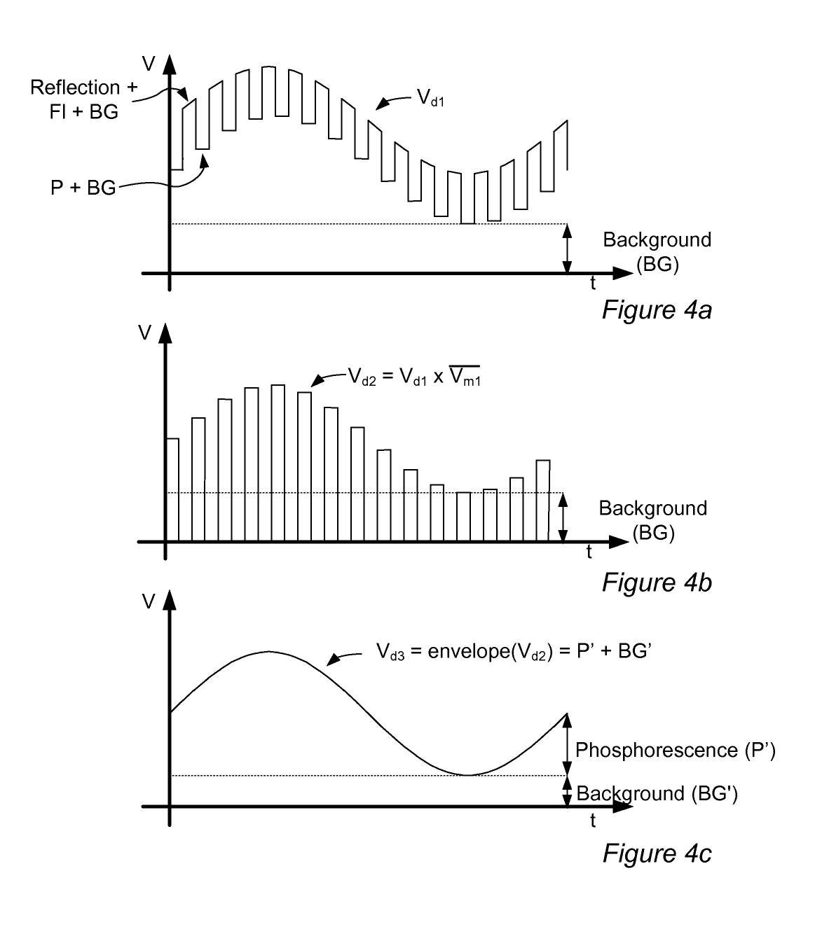

FIG. 2 shows a simplified circuit schematic illustrating key components of the photoemitter driver circuitry 20 and photodetector processing circuitry 24 of FIG. 1 according to one possible implementation. FIGS. 3a to 3d show, by way of illustration only, electronic signals at different points in the photoemitter driver circuitry 20, and the time varying intensity of the radiation emitted by the LED 18. FIGS. 4a to 4c show, by way of illustration only, signals at different points in the photodetector processing circuitry 24.

As seen in FIG. 2, a pair of oscillators 30 and 32 is provided for respectively generating the high frequency input signal (Vₘ₁) and a low frequency input signal (Vₘ₂).

The high frequency, or ‘fast’, oscillator 32 of this embodiment is configured to generate a high frequency input signal (Vₘ₁), as illustrated in FIG. 3a, comprising a two-level waveform (for example a square-wave). In this embodiment the high frequency waveform is at a frequency that is significantly higher than the reciprocal of the expected phosphorescence equivalent time constant for the sample 12 being tested. However, it will be appreciated that in some embodiments the high frequency waveform may have a frequency that is comparable to the reciprocal of the expected phosphorescence equivalent time constant for the sample 12 being tested. In this embodiment, Vₘ₁ has an exemplary frequency of 1 kHz. The high frequency two-level wave, Vₘ₁, produced by the fast oscillator 30 has a lower level that is substantially zero volts (or sufficiently low so to avoid the LED 18 becoming illuminated) and a high level that is sufficient, when Vₘ₁ and Vₘ₂ are multiplied, to ensure that the LED 18 is illuminated when Vₘ₁ is high.

The low frequency, or ‘slow’, oscillator 32 of this embodiment is configured to generate a low frequency input signal (Vₘ₂), as illustrated in FIG. 3b, comprising a sinusoidal waveform with a frequency that is significantly lower than the reciprocal of the expected phosphorescence equivalent time constant for the sample 12 being tested. Advantageously, the frequency is selected to be distinct from the frequency of any sources of interfering light (commonly harmonics of the mains supply frequency). In this embodiment, Vₘ₂ has an exemplary frequency of 10 Hz. The low frequency sinusoid, Vₘ₂, produced by the slow oscillator 32 has an offset such that the waveform remains positive throughout its wavelength. Typically, the magnitude of the offset is sufficiently high to ensure that, when Vₘ₁ and Vₘ₂ are multiplied, the LED 18 will be illuminated when Vₘ₁ is high (although this need not always be the case).

The signals Vₘ₁ and Vₘ₂ are inputted to a mixer 34 that is configured to produce an output signal (V_{C}), as illustrated in FIG. 3c, comprising the product of Vₘ₁ and Vₘ₂. The output signal, V_{C}, from the mixer 34 is provided as an input to a driver circuit 36 that is configured to generate an output current that is proportional to its input signal, V_{C}, for driving the LED 18.

The LED 18 emits light R₁, onto the sample 12, which has an intensity that is substantially proportional to the current that it is driven with, as illustrated in FIG. 3d. Accordingly, the LED 18 emits light R₁ having a generally sinusoidal intensity ‘envelope’ that varies slowly, relative to the reciprocal of the expected phosphorescence equivalent time constant for the sample 12 being tested, at the frequency of Vₘ₂. Within this sinusoidal ‘envelope’ the emitted light R₁ switches on and off intermittently at the high frequency.

The sample 12 photoluminesces, as a result of excitation by the incident light R₁, to produce a time-varying photoluminescence waveform, which is detected by the photodiode 22 along with light from other, parasitic, sources (e.g. as a result of reflection and/or background/ambient light). The photodiode 22 generates a time-varying current that is input to a photodetector circuit, comprising a preamplifier 38, that produces a time-varying signal (V_{d1}) that is substantially proportional to the light R₂ detected by the photodiode 22 (as illustrated in FIG. 4a).

The intensity waveform detected by the photodiode detector circuit has components due to several physical effects. During the short time periods when Vₘ₁ is zero (or at least sufficiently below the threshold voltage of the LED 18 to avoid illumination), the LED 18 is not illuminated and, accordingly, the sample 12 is not excited. Any fluorescence resulting from the previous excitation while Vₘ₁ was high is very short-lived, decaying almost instantaneously compared to the time during which Vₘ₁ remains low. Accordingly, the light R₂ emitted from the sample, and detected by the photodiode 22, is associated with phosphorescence, and any background light arising, for example, from ambient light. During the short time periods when Vₘ₁ is zero, therefore, the time-varying signal V_{d1}, includes a component (P) arising from the phosphorescence and a component (BG) arising from the background light and other parasitic effects such as leakage of the photodiode 22. The phosphorescence component of V_{d1}, P, remains approximately constant because the period of Vₘ₁ is short by comparison to the phosphorescence decay time, but is modulated by the excitation intensity when the LED 18 is illuminated.

During the short time periods when Vₘ₁ is high, the LED 18 is illuminated and, accordingly, the sample 12 is excited. During these periods, therefore, the light R₂ emitted from the sample, and detected by the photodiode 22, is associated with fluorescence, reflection, and any background light. Accordingly, during the short time periods when Vₘ₁ is high, the time-varying signal V_{d1}, includes: a component (FL) arising from the fluorescence; a component (BG) arising from the background light and other parasitic effects such as leakage of the photodiode 22; and a component associated with reflection of the incident light R₁. The response of the photodiode 22 when the LED 18 is illuminated is relatively large and, because the fluorescence decay time is relatively short compared to the period of Vₘ₁, tracks the sinusoidal envelope of the light waveform emitted by the LED 18.

In order to demodulate the high frequency component of the time-varying signal V_{d1}, a high frequency switched demodulator arrangement is used. In the switched demodulator arrangement, the high frequency input signal Vₘ₁ is inverted by the inverter 26, and the resulting inverted signal, V̅ₘ₁, fed to mixer 40 where it is multiplied by the output signal V_{d1} from the preamplifier circuit 38 to produce an output signal (V_{d2}) in which the components (FL and BG) arising when the LED 18 is illuminated are removed (as illustrated in FIG. 4b). It will be appreciated that appropriate delay components may be added to the circuit to ensure that the ‘lows’ (typically zeros) of the inverted signal, V̅ₘ₁, are synchronised with the ‘highs’ of the preamplifier output signal V_{d1} to ensure that the components arising when the LED 18 is illuminated are suppressed/inhibited successfully whilst the components arising when the LED 18 is not illuminated are not suppressed/inhibited but are instead passed to the next part of the circuit.

The output signal, V_{d2}, from the mixer 40 is then filtered (or ‘averaged’) by a low pass filter 42 to remove the switching component, effectively extracting the envelope of the mixer output signal, V_{d2}. The resulting wave-form (V_{d3}) includes a component (P′) arising from the phosphorescence and a component (BG′) arising from the background light and the other parasitic effects, but no components associated with fluorescence or reflection of the incident light R₁ (as illustrated in FIG. 4c). Accordingly, the signal components due to phosphorescence and parasitic effects have effectively been isolated. The low pass filter 42 may comprise any suitable filter circuitry to give an appropriate filter characteristic. Typically, however, the cut-off frequency of the low pass filter 42 would be at least an order of magnitude or so smaller than the frequency of Vₘ₁ (in this embodiment an exemplary value of 15 Hz is used).

The component, BG′, of the low pass filter output, V_{d3}, due to any background radiation and other parasitic effects is thus substantially static, whilst the component, P′, arising from the phosphorescence is dynamic (in this case sinusoidal) oscillating at the slow oscillation frequency of Vₘ₂. The magnitude of the dynamic component, P′, arising from the phosphorescence therefore represents the phosphorescence of the sample 12.

The low pass filter output, V_{d3}, is amplified using an amplifier 44. The amplifier 44 is arranged to amplify signals having a frequency in a region corresponding to that of the low frequency input signal, Vₘ₂, with a bandwidth set by the overall measurement bandwidth. In this embodiment the amplifier 44 comprises an AC coupled, large gain, amplifier having an exemplary bandwidth of 5 Hz to 15 Hz (i.e. centred on the exemplary 10 Hz frequency of Vₘ₂). Beneficially, because the desired information representing the sample phosphorescence is contained in the magnitude of a sinusoid of known frequency, it is possible to apply a very large gain to the signal without encountering problems associated, for example, with amplifier offset or background magnification.

The low frequency sinusoid, Vₘ₂, produced by the slow oscillator 32 is also input to the high-pass filter 28, to remove the static offset component and thereby zero centre the low frequency input signal, Vₘ₂, thereby producing a bipolar version, Vₘ₂₍₀₎. The resulting bipolar version, Vₘ₂₍₀₎, of the low frequency input signal, Vₘ₂, and the output from the large gain amplifier 44 are multiplied together using a mixer comprising a linear multiplier 46. The resultant output signal from the linear multiplier 46 is then filtered, by a further low pass filter 48, using an appropriate measurement bandwidth, to produce a filtered final output signal (Vₚ) from which the low frequency sinusoidal components of the linear multiplier output signal have, effectively, been eliminated. Accordingly, the magnitude of the final output signal, Vₚ, output by circuit of FIG. 2 represents a measurement of the amplified sinusoid from which information about the phosphorescence of the sample 12 can be extracted independently of any signals associated with the background/ambient light, other parasitic effects, and the fluorescence of the sample. This measurement technique can be made highly sensitive due to the large amplification that may be applied by the large gain amplifier 44.

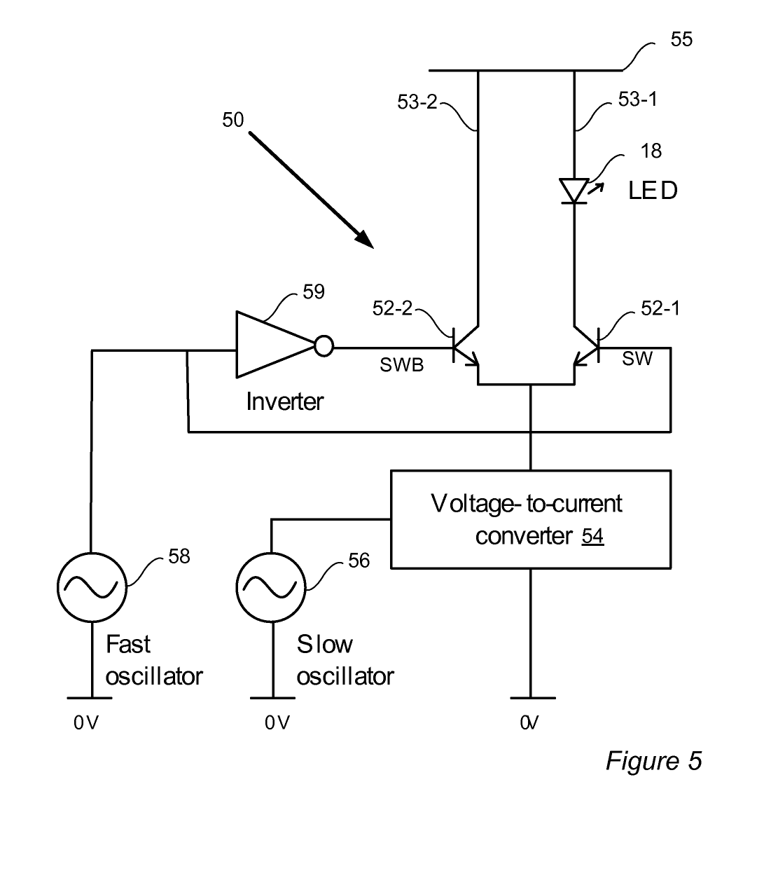

FIG. 5 shows a simplified circuit schematic of an example of photoemitter drive circuitry 50, for another embodiment of the invention, in more detail.

As seen in FIG. 5, the driver circuitry comprises a pair of semiconductor switches 52-1, 52-2 which, in this example, comprise bipolar junction transistors (BJTs). The BJTs 52 in this example are NPN type BJTs although it will be appreciated a similar circuit could be adapted to use PNP type BJTs. Each BJT 52 has an emitter that is coupled to the emitter of the other BJT 52, in a manner similar to a ‘long-tailed pair’ arrangement. The emitters of the BJT 52 are coupled to ground (or possibly a negative power rail) via a voltage to current converter 54.

The radiation emitting device 18 being driven by the circuit 50, is provided in a first current branch 53-1 of the circuit 50 between a collector of one of the BJTs 52-1 (the ‘driver’ BJT) and a high voltage rail 55. A collector of the other BJT 52-1 is connected directly to the high voltage rail 55 to provide a second current branch 53-2 of the circuit.

An oscillator 56, operating as a ‘slow’ oscillator as described previously, provides the low frequency input signal Vₘ₂ to the voltage to current converter 54 to modulate the current through the emitters of the BJTs 52.

An oscillator 58, operating as a ‘fast’ oscillator as described previously, provides the high frequency input signal Vₘ₁ to a base of one of the BJTs 52-1 and to an inverter 59 to generate an inverted version of the high frequency input signal. The inverted version of the high frequency input signal is provided to the base of the other of the BJTs 52-2. Accordingly, when the signal from the fast oscillator 58 is high, the driver BJT 52-1 is in an ‘ON’ state and the other BJT 52-2 is in an ‘OFF’ state, and the current flows through the first current branch 53-1 thereby driving the radiation emitting device 18. When the signal from the fast oscillator 58 is low, the driver BJT 52-1 is in an ‘OFF’ state and the other BJT 52-2 is in an ‘ON’ state, and the current flows through the second current branch 53-2. Thus, the fast oscillator 58 effectively switches current flow through the emitter coupled ‘tail’ of the BJT pair 52 between one current branch 53-1 to the other current branch 53-2 thereby modulating the current flow through the radiation emitting device 18.

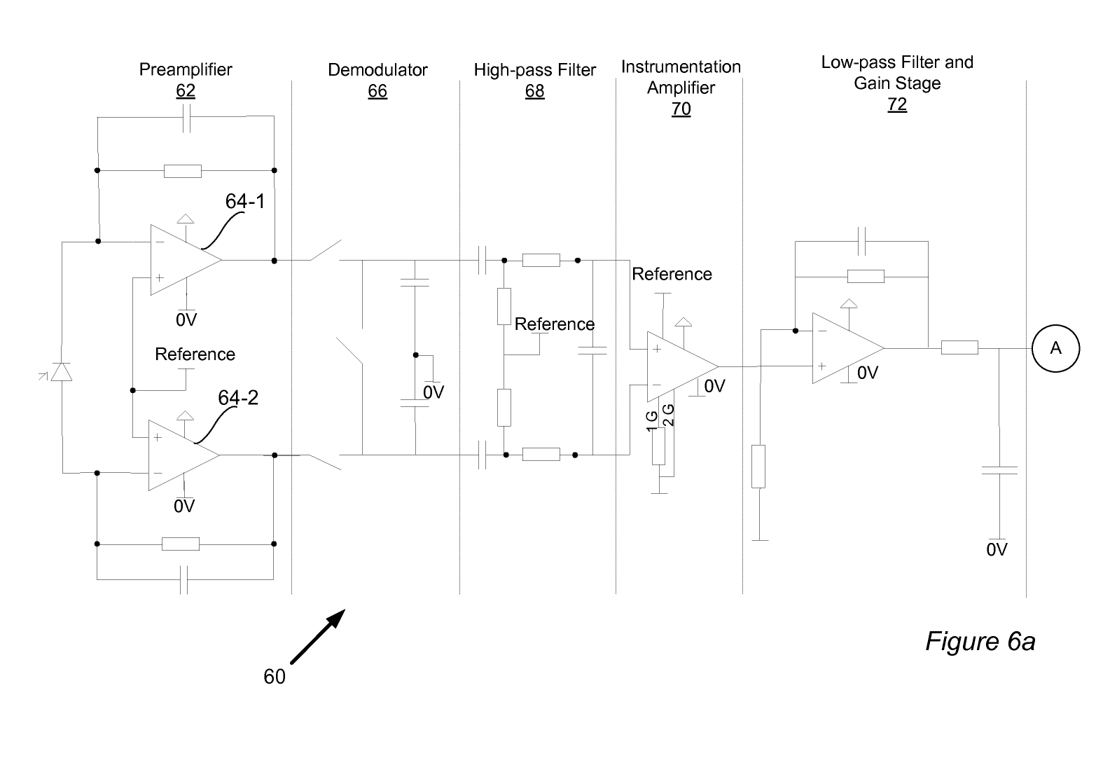

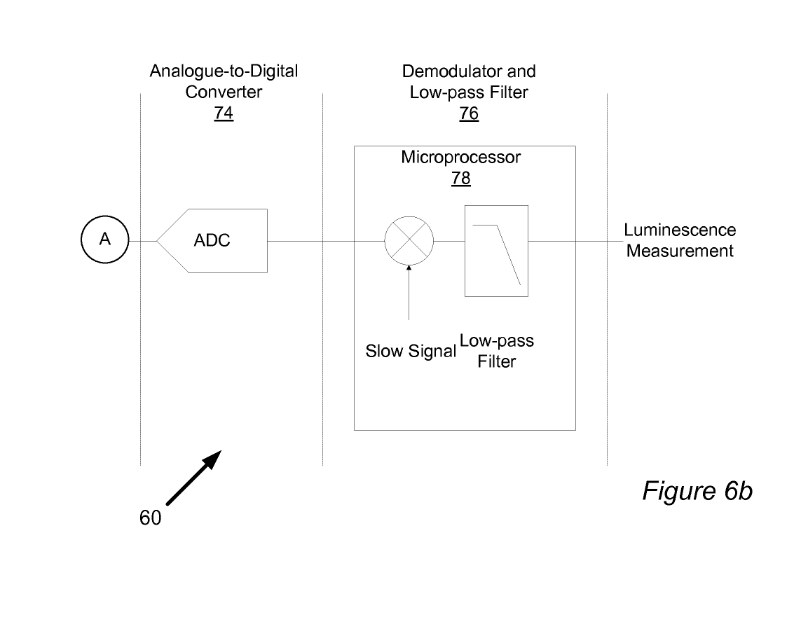

FIGS. 6a and 6b show a simplified circuit schematic of an example of photoreceiver circuitry 60, for another embodiment of the invention, in more detail.

As seen in FIG. 6a, the photoreceiver circuitry 60 comprises a preamplifier circuit stage 62 comprising a pair of operational amplifier circuits 64 arranged to generate a time varying output signal in dependence on the light detected by the photodiode 22. A switched demodulator stage 66, demodulates the signal output from the preamplifier 62 with respect to the high frequency modulation signal.

When the LED 18 is turned off, the two switches at the outputs of the operational amplifiers 64-1 and 64-2 are closed, and the switch connecting the two outputs remains open. In this state, the signal coming from the photodiode is amplified and filtered by the subsequent electronics. When LED 18 is turned on, the two switches at the outputs of the operational amplifiers 64-1 and 64-2 are open and the switch connecting the two outputs is closed. In this state, the signal coming from the photodiode is not propagated further down the signal chain. The two switches at the outputs of the operational amplifiers 64-1 and 64-2 are driven by an inverted version of the fast oscillator, whereas the switch across the two lines is driven by a non-inverted version of the same oscillator.

The demodulated signal from the demodulator 66 is filtered, using a high pass filter stage 68, to remove low frequency and semi-static components (e.g. components below the frequency of the slow oscillator signal such as components associated with background radiation). The filtered output of the high pass filter 68 is then amplified by an amplifier stage 70 and the resulting amplified signal is filtered, by a low pass filter and gain stage 72, to remove remaining high frequency components of the signal (e.g. components above the frequency of the slow oscillator signal). At this stage, the signal is equivalent to the output of the AC coupled, large gain, amplifier 44 described previously.

Referring now to FIG. 6b, the output from the low pass filter 72, in this embodiment, is converted into a digital signal using an analogue to digital converter (ADC) 74, and further processing of the signal, to extract the luminescence characteristic of interest, is achieved using a demodulation and low-pass filter stage 76, comprising a microprocessor 78.

In this embodiment, the microprocessor 78 is programmed to multiply the digitised output of the low pass filter 72 together with a zeroed version of the slow input signal. The microprocessor 78 filters the resulting signal product to remove the low frequency sinusoidal components, in a similar manner to that described previously, to produce a result that is representative of the amplitude of the sinusoidal input to the ADC 74. From this resultant signal, the phosphorescence of the sample 12 can be extracted independently of any signals associated with the background/ambient light, other parasitic effects, and the fluorescence of the sample. This measurement technique can be made highly sensitive due to the large amplification that may be applied by the amplifier stage 70.

### Modifications and Alternatives

Detailed embodiments have been described above. As those skilled in the art will appreciate, a number of modifications and alternatives can be made to the above embodiment whilst still benefiting from the inventions embodied therein.

An optical filter may, for example, be placed between the LED 18 and the sample 12 (and/or between the photodiode 22 and the sample) such that it blocks light of a similar wavelength to that expected for the phosphorescence. The filter may, for example comprise a UV-pass filter or the like. This arrangement beneficially thereby inhibits luminescence from the radiation emitting side of the apparatus from contaminating the measurement and can therefore help to enhance sensitivity.

In another variation on the described embodiment, the demodulation of the high frequency component of the light detected by the detection circuit may advantageously be achieved by use of a photodiode detector circuit whose gain can be switched between a high mode (when the LED 18 is off) and a low mode (when the LED 18 is on), for example under the control of the inverted high frequency signal. This can be advantageous over the use of the fixed-gain detector circuit, and switched demodulator, described for the above embodiment because it can reduce the detection dynamic range and simplify the implementation.

It will be appreciated that whilst the signals have been described as having frequencies of 10 Hz and 1 kHz, the frequencies may be any suitable value. For example, the lower frequency signal will generally be 10 Hz or lower, although in some cases it may be higher. Similarly, the higher frequency signal will generally be 1 kHz or higher, although in some cases it may be lower.

In one exemplary embodiment, for example, a slow square wave signal with a frequency of 5 Hz (a period of 200 ms) and a fast modulation signal of 2.5 kHz (a period of 400 μs) are used. In this exemplary embodiment, a dye with a phosphorescence lifetime of approximately 640 μs is used in the sample. In other exemplary embodiments, however, dyes are used that have time constants in the order of 1200 μs and 2400 μs and for which the fast modulation frequency is commensurately lower (in these the slow modulation frequency of 5 Hz may remain unaffected).

It will also be appreciated that whilst a sinusoidal low frequency input signal Vₘ₂ has advantages, Vₘ₂ may be any suitable waveform such as a two-level (e.g. square) or other shape waveform.

Further the frequencies of the high frequency input signal Vₘ₁ and/or the low frequency input signal Vₘ₁ may be tunable to the characteristics of a particular sample or a particular component of a sample. In a particularly beneficial example, the frequency of the high frequency input signal Vₘ₁ may be adjustable, between a plurality of different frequencies, to allow multiplexing between samples having different luminescent properties (e.g. with different characteristic time constants) and/or to multiplex between different components of a particular sample, each component having a different luminescent property (e.g. a different characteristic time constant). The adjustability of the frequency may be operator controlled or may be automated, for example with the apparatus automatically (or manually) being cycled through a set of pre-set frequencies to allow detection of the presence (or absence) of specific components having specific luminescent characteristics. This arrangement is particularly beneficial in applications where spectral discrimination and/or spatial discrimination between different samples (or different components of a particular sample) is not possible or is undesirable.

Whilst the final demodulation step comprising multiplication of a high-pass filtered version, Vₘ₂₍₀₎, of the low frequency input signal, Vₘ₂, with the amplified version of V_{d3} is particularly advantageous, it will be appreciated that the final demodulation step may be carried out using other appropriate circuitry. For example, an envelope detector may beneficially be used if the measurement bandwidth and the frequency of the low frequency input signal, Vₘ₂, are such that the final low-pass filter can have a cut-off frequency that is significantly lower than the slow oscillation frequency. Alternatively, where a two-level low frequency input signal, Vₘ₂, is used instead of a sinusoidal signal, the linear multiplier 46 can be replaced by a simple switched demodulator.

It will be appreciated that the incident radiation R₁ may comprise any radiation suitable for exciting the sample to luminesce, although ultraviolet (UV) radiation is particularly beneficial. Where the radiation is UV it may have a wavelength in the range of about 400 nm down to about 10 nm (energies of about 3 eV to about 124 eV). The radiation may, for example be radiation in a ‘near’ UV spectral region having a wavelength of between about 400 nm and about 300 nm (˜3.10 eV to ˜4.13 eV), in a ‘middle’ UV region having a wavelength of between about 300 nm and about 200 nm (˜4.13 eV to ˜6.20 eV), in a ‘far’ UV region having a wavelength of between about 200 nm and about 122 nm (˜6.20 eV to ˜10.2 eV), and/or in a in a ‘extreme’ UV region having a wavelength of between about 121 nm and about 10 nm (˜10.2 eV to ˜124 eV). The radiation may, for example, be UVA radiation having a wavelength of between about 400 nm and about 315 nm (˜3.10 eV to ˜3.94 eV), UVB radiation having a wavelength of between about 300 nm and about 280 nm (˜3.94 eV to ˜4.43 eV), UVC radiation having a wavelength of between about 280 nm and about 100 nm (˜4.43 eV to ˜12.4 eV), and/or Vacuum UV (‘VUV’) radiation having a wavelength of between about 200 nm and about 10 nm (˜6.2 eV to ˜124 eV). UV having a wavelength of around 365 nm or around 265 nm has been of particular benefit.

Whilst the above embodiments have been described with reference to, and have particular benefits in the measurement of phosphorescent (time-resolved fluorescence/luminescence) properties of samples used in biological assays or the like, it will be appreciated that the measurement methods and apparatus described above may be used in a wide range of other applications. For example, the measurement techniques and apparatus could be applied beneficially in anti-counterfeiting, authentication, security and/or forensic applications including, inter alia: authentication of documents (e.g. licences, certificates, identity documents, passports, documents supporting financial transactions and/or the like); asset protection/identification by marking assets with a ‘smart’ (and possibly invisible) chemical or biological marker which can be identified using the techniques described above (e.g. to confirm ownership of stolen goods or the like); verification of the presence of anti-counterfeiting measures (e.g. applied to branded goods); and characterisation of forensic samples (e.g. found at a crime scene). Similarly, the measurement techniques and apparatus could be applied beneficially in industrial sensing applications such as, for example: fluid leak testing; the detection of contaminants; seal integrity testing; quality control; determining the presence or absence of specific objects in a defined area (e.g. full or empty packaging); etc.

For constructing the present apparatus, those skilled in electronics design will recognize that the various components may be implemented in a variety of ways. Thus, for example, the demodulator may be implemented in software, hardware, or a combination of hardware and software. Likewise, the signal generator may utilize many different designs. Such range of designs for the apparatus components are included in the invention.

### D. Coating to Reduce Non-Specific Binding and Layered Labels

In the conduct of many types of assays, non-specific binding is a major issue requiring resolution. Included in such situations is non-specific binding involving particular labels, such as enzymes, colored moieties, fluorescent particles, e.g., polystyrene particles bearing internal and/or external fluorescent moieties. In many cases, a coating is used, such as coating with BSA or with various synthetic polymers. However, in many cases, the single coating layers applied are inadequate so that appreciable and problematic non-specific binding still occurs.

Thus, the present invention also concerns labels which are coated in ways which advantageously reduce non-specific binding to assay surfaces and can also provide functional groups for attachment of additional moieties, e.g., full-coated labels, such as layered labels and/or as fully linked coating labels.

As indicated, some applications of the present invention utilize layered labels, which include multiple layers of coatings, e.g., 2, 3, 4, 5, or even more layers. An important application of such multiple layers of coatings is to reduce non-specific binding, but they can alternatively or in addition be used to carry detectable label moieties and/or other functional moieties. In most cases, the coatings, or at least the outer layers (e.g., outer two layers), are hydrophilic materials, typically hydrophilic polymers. The coating layers may be retained in place by interactions with the layer below and/or by intereactions within the particular layer. Such interactions include, for example, electrostatic interactions and covalent bonding. In advantageous embodiments, the coating is water permeable. Further, advantageous embodiments of such water permeable coatings have sufficiently open structure to allow access of water soluble molecules such as enzyme substrates, energy transfer dyes, and the like to penetrate below the top or outermost coating layer, and preferably even to layers lower than the second layer.

Thus, for example, a solid phase particle may be used as the core of the layered label which has detectable label moieties in and/or on the particle. The solid phase particle may be functionalized with a suitable reactive group (e.g., hydroxyl or carboxy) which can react with or be modified to react with functional groups in a first coating material. In many case, in order to functionalize the particle, it is first treated, e.g., by corona treatment, gas (e.g., air or oxygen) plasma treatment, flame plasma treatment, or chemical plasma treatment. Commonly such treatment introduces a functional group which may be used directly or used for attaching to or converting to a different functional group.

The first coating material includes either excess functional groups or another type of functional group which can be used to react with functional groups in a second coating. A similar process can be followed for additional coating layers. For example, alternating carboxy and amine functional groups may be used. In many cases, the outermost coating will be bound with a binding moiety, e.g., a member of a specific binding pair, such as one of a steptavidin (or avidin) biotin pair, or one of an antibody/antigen pair, or a receptor/ligand pair, or artificially derived specific binding pair. That binding moiety allows, for example, the particle to subsequently bind directly or indirectly with an analyte, such as in a sandwich arrangement.

For example, streptavidin may be attached to the coating. A biotinylated antibody binding to a particular cell surface antigen or other accessible moiety on the particle can then be used to link the layered label with the target particle, e.g., target cell. Of course, the system may be simplified, e.g., with an antibody attached to the coating, where that antibody binds to the target cell or other target particle. Spacers or linkers can also be included, e.g., to reduce steric hindrance to binding.

The layered labels can be configured in a number of additional ways. The layering may be formed on a core solid phase particle, e.g, a polystyrene particle, as mentioned above, where the particle bears detectable label moieties. Alternatively, the coating or moieties embedded in or attached to the coating may provide the detectable labels (alone or in conjunction with detectable labels directly associated with the core solid phase particle). Thus, for example, a layer may be coated over the solid phase particle, and detectable label moieties can be attached to or co-deposited with that coating. At least one additional coating may be laid over the first coating. Such additional coating can also have attached detectable labels, or the additional coating covers the label moieties attached to a lower coating layer or layers. Use of core solid phase particles usually provides a larger label, and may be useful, for example, to allow sufficient detectable label moieties to be present to provide desired signal intensity.

As another alternative, the core solid phase particle may be dispensed with, and a layered label may be created with multiple coating layers. In this case, the detectable label moieties are attached to or co-deposited with particular layers. One advantage of such a configuration is that the resulting layered label can contain multiple, even a large number, of individual label moieties. For example, if the label moiety is an enzyme, multiple enzyme molecules can be immobilized within the layered structure. Other types of label moieties can similarly be incorporated within the layered structure. As indicated previously, preferably the characteristics of the layer material (usually a hydrophilic material such as hydrophilic polymer such as a polydextran) allow fluid access to and/or detection of the internal label moieties.

As indicated, any of a variety of functional groups may be used for linking adjacent layers, for attaching detectable label moieties (e.g., dyes), and for attaching specific binding moieties (e.g., members of specific binding pairs). Important, commonly used groups for conjugation involve amine reactive, sulfhydryl reactive, carbohydrate reactive, carboxyl reactive, n-hydroxy succinamide active, photoreactive and/or ionic interactions. Exemplary groups include alcohol (e.g., as in ethanol), aldehyde (e.g., as in acetaldehyde), alkene (e.g., as in ethylene), alkyne (e.g., as in acetylene), amide (e.g., as in acetamide), primary amine (e.g., as in lysine), secondary amine (e.g., as in thymine), tertiary amine (e.g., as in triethylamine), carbonyl, carboxylic acid, disulfide, ester, ether, alkyl halide, ketone, nitrile, nitro, sulfide, thioester, thiol, epoxide, azide, N-hydroxy succinamide, anhydride, maleimide group, isothiocyanate, fluoroacyl imidazone, silane derivatives, silazane, and borate.

Linking functional groups can be used in connection with a large variety of polymers, including natural polymers, modified natural polymers, semi-synthetic polymers, and synthetic polymers. Examples of natural polymers which may be used for coating include complex mixtures such as serum, polypeptides (e.g., proteins such as BSA, casein, ovalbumin, lectins, or fibrinogen) and polysaccharides ((e.g., polysucrose, β-cyclodextrin-polysucrose polymer, dextrins (including both linear and cyclodextrins), dextrans (linear and branched), and chitin.

A number of synthetic polymers which may be used for coating, such as polyethylene glycol (PEG), polyvinyl chloride (PVC), polyvinyl alcohol (PVA), polyvinyl pyrrolidone (PVP), and non-ionic detergents such as Nonidet P-40 (NP-40) and Tween 20. Additional options are listed in the tables below.

| Name(s) | Formula | Monomer |
|---|---|---|
| Polyethylene | —(CH₂—CH₂)ₙ— | Ethylene |
| low density (LDPE) | | CH₂═CH₂ |
| Polyethylene | —(CH₂—CH₂)ₙ— | Ethylene |
| high density (HDPE) | | CH₂═CH₂ |
| Polypropylene | —[CH₂—CH(CH₃)]ₙ— | Propylene |
| (PP) different grades | | CH₂═CHCH₃ |
| Poly(vinyl chloride) | —(CH₂—CHCl)ₙ— | vinyl chloride |
| (PVC) | | CH₂═CHCl |
| Poly(vinylidene chloride) | —(CH₂—CCl₂)ₙ— | vinylidene chloride |
| (Saran A) | | CH₂═CCl₂ |
| Polystyrene | —[CH₂—CH(C₆H₅)]ₙ— | Styrene |
| (PS) | | CH₂═CHC₆H₅ |
| Polyacrylonitrile | —(CH₂—CHCN)ₙ— | acrylonitrile |
| (PAN, Orion, Acrilan) | | CH₂═CHCN |
| Polytetrafluoroethylene | —(CF₂—CF₂)ₙ— | tetrafluoroethylene |
| (PTFE, Teflon) | | CF₂═CF₂ |
| Poly(methyl methacrylate) | —[CH₂—C(CH₃)CO₂CH₃]ₙ— | methyl methacrylate |
| (PMMA, Lucite, Plexiglas) | | CH₂═C(CH₃)CO₂CH₃ |
| Poly(vinyl acetate) | —(CH₂—CHOCOCH₃)ₙ— | vinyl acetate |
| (PVAc) | | CH₂═CHOCOCH₃ |
| cis-Polyisopreme | —[CH₂—CH═C(CH₃) —CH₂]ₙ— | Isoprene |
| natural rubber | | CH₂═CH—C(CH₃)═CH₂ |
| Polychloroprene (cis + | —[CH₂—CH═CCl—CH₂]ₙ— | Chloroprene |
| trans) | | CH₂═CH—CCl═CH₂ |
| (Neoprene) | | |

| Monomer A | Monomer B |
|---|---|
| H₂C═CHCl | H₂C═CCl₂ |
| H₂C═CHC₆H₅ | H₂C═C—CH═CH₂ |
| H₂C═CHCN | H₂C═C—CH═CH₂ |
| H₂C═C(CH₃)₂ | H₂C═C—CH═CH₂ |
| F₂C═CF(CF₃) | H₂C═CHF |

| Formula | Type | Components |
|---|---|---|
| ~[CO(CH₂)₄CO—OCH₂CH₂O]ₙ~ | polyester | HO₂C—(CH₂)₄—CO₂H |
| | | HO—CH₂CH₂—OH |
| 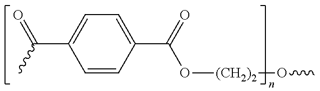 | polyester Dacron Mylar | Para HO₂C—C₆H₄—CO₂H HO—CH₂CH₂—OH |
| 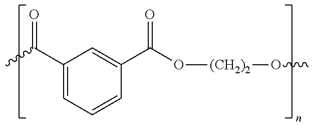 | polyester | Meta HO₂C—C₆H₄—CO₂H HO—CH₂CH₂—OH |
| 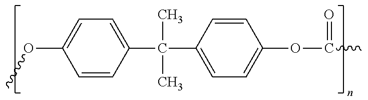 | polycarbonate Lexan | (HO—C₆H₄—)₂C(CH₃)₂ (Bisphenol A) X₂C═O (X = OCH₃ or Cl) |
| ~[CO(CH₂)₄CO—NH(CH₂)₆NH]ₙ~ | polyamide Nylon 66 | HO₂C—(CH₂)₄—CO₂H H₂N—(CH₂)₆—NH₂ |
| ~[CO(CH₂)₅NH]ₙ~ | polyamide Nylon 6 Perlon | 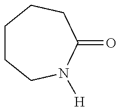 |
| 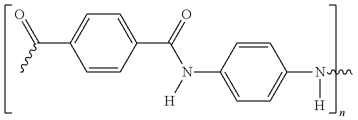 | polyamide Kevlar | Para HO₂C—C₆H₄—CO₂H para H₂N—C₆H₄—NH₂ |
| 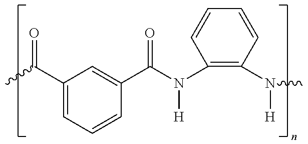 | polyamide Nomex | Meta HO₂C—C₆H₄—CO₂H meta H₂N—C₆H₄—NH₂ |
| 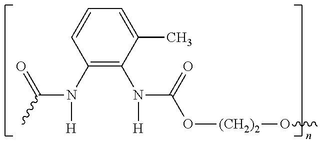 | polyurethane Spandex | 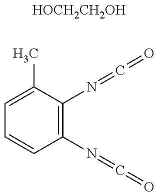 |

In addition to polymers formed of a single type of monomers, co-polymers can also be useful. As example of such a co-polymer is ABS rubber, which is a terpolymer of acrylonitrile, butadiene and styrene, and is commonly used for high-impact containers, pipes and gaskets.

Adjacent coating layers may formed of the same or different polymeric material depending on the desired properties. However, at least the outermost or two outermost layers should be selected to provide very low non-specific binding for proteins and/or other materials for which non-specific binding is undesirable in the particular assay.

In addition to layered labels, fully linked coating labels can be advantageous. Such labels differ from conventional coated labels in having a coating which is densely linked. For example, a protein such as BSA can be utilized and linked to a particle through accessible amine groups in the protein. When reacted at a high level the protein forms a substantially complete coating, and substantially all of the previously amine groups have been reacted. To provide new functional groups, e.g., for attachment of specific binding moieties, detectable label moieties, and/or other desired moieties, disulfide bonds can be reduced, making available —SH groups for such attachments.

Individuals familiar with this field will understand how to apply and link layers of various polymers using any of a number of different chemistries, and further how to attach binding moieties (e.g., a member of a specific binding pair, for example, streptavidin/biotin, antibody/antigen, or receptor/ligand (or ligand analog). A number of polymer materials suitable for this purpose are readily available.

### E. Multiplexing

Advantageously, a number of the present assay formats can be multiplexed, allowing detection of multiple analytes at the same time. Such multiplexing is of particular benefit in applications in which a panel of analytes or markers is used as a diagnostic tool, e.g., for one or more diseases or conditions or for multiple drug detection assays.

The particular method by which multiplexing is accomplished will typically vary depending on the type of label used for detection and/or the ability to spatially segregate signal generation for different analytes.

In the present invention, when using TRF labels the following multiplexing methods can be used, separately or in any combination. Except for multiplexing which involves time resolved signals, these methods may also be used for other luminescent detection methods.
1. In one approach, distinguishable detectable signals are produced from labels having different emission wavelengths.
2. Another way of multiplexing is to use labels which have different excitation wavelengths. Such labels may have the same or different emission wavelengths.
3. With TRF labels, an additional multiplexing technique can be used based on TRF labels having significantly different signal decay times. Such multiplexing For example, if two TRF labels are used which excite and emit at substantially the same wavelength, but which have significantly different signal decay times, two reading windows can be used. If Label 1 has a significantly shorter signal decay time than Label 2, then the first reading is taken at a time after excitation such that the detected signal includes components from both labels, while the second reading is taken after the signal from Label 1 has decayed significantly more than the signal from Label 2, often when the Label 1 signal has substantially completely decayed. With known signal decay characteristics for the two labels, the component from Label 1 at the first reading can be calculated by subtracting the signal component from Label 2. The analysis may be extended to additional labels which have significantly different lifetimes, where the contribution from the longest lifetime label is determined first, and the contributions from the successively shorter lifetime labels are determined by subtracting the contributions of the longer lifetime labels at one or more earlier timepoints, usually at timepoints where the signal contributions from still shorter lifetime labels are substantially zero. Alternatively, the contribution from each label may be determined by determining the contributions to the shape of the signal decay curve by curve fitting. The shape of the signal decay curve for each label is known and can be described by an equation derived by conventional methods. In an assay, multiple, preferably a large number of, readings are taken, defining an assay signal decay curve. The contributions of each label to the decay curve are determined by conventional curve fitting methods.
4. Detection zones for different analytes may be spatially separated on a solid phase substrate, e.g., a lateral flow device. This allows multiplexing based on zone separation. Such zone separation may be accomplished by immobilizing the respective capture agents (e.g., antibodies) at distinguishably different locations.

For the first multiplexing approach listed above, the simplest method is merely to select single dyes and/or chelates which emit at different wavelengths, and which may be excited at the same and/or different wavelengths. This simple approach is limited by the number of single dyes and/or chelates available which can be used in the same conditions. However, the number can be significantly expanded by energy coupling in which a single acceptor dye is coupled to multiple different emitter dyes. This can be done in a manner conventional for energy coupling, or can be performed as a double coupling. In the double coupling approach, an initial fluorescent dye is the acceptor. Light emission from the acceptor dye excites an intermediate dye which generates singlet oxygen upon excitation by light of an appropriate wavelength. The singlet oxygen excites a chemiluminescent compound which emits the signal (which may be a TRF signal). In this approach, there are a large number of such chemiluminescent compounds which emit at different wavelengths, resulting in the ability to discriminate different analytes. Such coupling may be readily combined with use of acceptor dyes which absorb at different wavelengths and/or spatial discrimination. Similarly, the singlet oxygen-generating dye may be used as the acceptor, with the light emitted by that dye absorbed either by a chemiluminescent dye which emits light in response to singlet oxygen, and an emitter dye which is excited by the light emitted by the chemiluminescent dye. The emitter dye may, for example be TRF label dye, e.g., an appropriate lanthanide chelate or metalloporphyrin.

As indicated, the multiplexing approaches described above can be utilized alone or in any combination. Thus, referring to the numbering in the list above, the combinations include (1,2), (1,3), (1,4), (1,2,3), (1,2,4), (1,2,3,4), (2,3), (2,4), (3,4), and (2,3,4).

### F. Assay Devices and Assay Formats

The present methods, materials, and platforms are applicable to a number of different assay formats. As indicated herein, many useful assay formats use an assay cartridge, e.g, in a lateral flow format. Numerous such devices have been described and can be used in the present invention.

The present invention also involves certain novel assay formats and associated reagents and kits. These assay formats can advantageously, but do not necessarily, include use of the full-coat labels such as layered labels or fully linked coating labels as described above. These assay formats are particularly advantageous for small laboratory, medical point of care, and/or home assays. In preferred cases, the assay is performed using a lateral flow assay device, preferably approved for use as a small laboratory, point of care, and/or home care diagnostic device. The assay devices can be configured as qualitative (presence/absence), semi-quantitive (above or below a threshold or within a specified range), or quantitative (distinguishing various levels of analyte in samples and optionally giving a numerical result) devices.

One device which can be used as part of the present assay platform is described in Mpock et al., Pat Publ US 2009/0117666, application Ser. No. 11/936,258, which is incorporated herein by reference in its entirety. While the device may be used as described therein, it may also be modified. For example, different sample preparation features (e.g., blood separation) may be incorporated. In addition (or alternatively, rather than detecting signal in the region 70, the device may be modified such that label binding occurs prior to the fluid entering a capillary region, and the signal is detected in flow through that capillary region. With this modification it is possible to detect single-event binding.

As indicated, in some applications, assays can be formatted as lateral flow assays (also referred to as strip assays) such as those described in Davis, Davis et al U.S. Pat. No. 4,889,816; Davis et al; Davis et al U.S. Pat. No. 7,238,537; May et al U.S. Pat. No. 5,275,785; May U.S. Pat. No. 5,602,040; May et al U.S. Pat. No. 5,656,503; May et al U.S. Pat. No. 5,622,871; May et al U.S. Pat. No. 6,228,660; May U.S. Pat. No. 6,156,271; May et al U.S. Pat. No. 6,187,598; May et al U.S. Pat. No. 7,109,042; May U.S. Pat. No. 6,818,455; Charlton et al U.S. Pat. No. 5,714,389; Charlton U.S. Pat. No. 6,485,982; Charlton et al U.S. Pat. No. 5,989,921; Charlton U.S. Pat. No. 5,786,228; Charlton U.S. Pat. No. 5,786,227; Charlton U.S. Pat. No. 5,981,293; Charlton et al U.S. Pat. No. 6,673,614; Jeng et al U.S. Pat. No. 5,064,541; Malick et al U.S. Pat. No. 5,998,221; Malick et al U.S. Pat. No. 6,194,220; Schuler et al U.S. Pat. No. 5,798,273; Clayton et al U.S. Pat. No. 5,182,216; Gordon et al U.S. Pat. No. 4,956,302; Jobling et al U.S. Pat. No. 6,130,100; Penfold et al U.S. Pat. No. 6,133,048; and Ching et al. U.S. Pat. No. 5,780,308, each of which is incorporated by reference in its entirety. A related assay and device is described in Allen, U.S. Pat. No. 5,580,794 which is incorporated herein by reference in its entirety.

In some applications of the present invention, assays and assay devices as described in the patents listed above are used with a label which is multiply layered as described above. In the above-listed patents, the assays generally utilize binding reagent immobilized in a reagent pad. Sample is applied upstream of the reagent pad, mobilizing the reagent and coating a strip in contact with but downstream of the reagent pad. Nitrocellulose is commonly used for the strip surface. The strip is also in contact with a fluid sink, so that the sample is drawn through the reagent pad, across the strip, and into the fluid sink. The reagent includes a binding reagent which binds to analyte in the sample. The strip includes a detection zone (i.e., signal detection zone) where analyte in the sample is immobilized, along with corresponding binding reagents from the reagent pad, generally in a sandwich arrangement. In the above-listed patents, the detectable labels are directly detectable, but indirectly detectable labels, such as fluorescent labels, can also be used.

Another set of strip assay formats that can utilize the present layered labels are wet assay formats. In such wet assay formats, the binding reagent is not dried in a reagent pad linked between a sample pad and a membrane strip as generally described for the patents listed above, but instead is added to the solid phase, either together with or separately from the liquid sample. Thus, for example, the sample and binding reagent can be mixed together and the mixture applied to the assay strip.

In another variant, the binding reagent in a lateral flow assay device is dried on the membrane rather than in a reagent pad) between a sample application zone and a signal detection zone.

In certain particularly advantageous formats, fluids in an assay device are physically manipulated by applied forces. Such manipulation is useful, for example, for mixing and/or for fluid movement and/or for droplet formation. For example, fluids can be manipulated using electrical or magnetic fields. Among other advantages, these approaches allow manipulation of fluids in an assay device with essentially no loss of fluid. This makes possible the construction of assay devices which utilize very small sample volumes, e.g., 1-5 microliters. Advantageous fluid manipulation techniques allow fluid manipulation in droplet form.

For example, such fluid manipulation can be performed using electrowetting effects, e.g., as described in Pamula et al., US Pat Appl Publ 2007/0045117, entitled Apparatuses for Mixing Droplets; Pamula et al., U.S. Pat. No. 6,911,132, iss. Jun. 28, 2005, entitled Apparatus for Manipulating Droplets by Electrowetting-Based Techniques; US Pat Appl Publ 2007/0037294, entitled Methods for Performing Microfluidic Sampling; US Pat Appl Publ 2007/02410, entitled Droplet-Based Washing; US Pat Appl Publ 2007/0243634, entitled Droplet-Based Surface Modification and Washing; and US Pat Appl Publ 2008/0105549, entitled Methods for Performing Microfluidic Sampling, each of which is incorporated herein by reference in its entirety for all purposes, specifically including for their descriptions of fluid mixing and other fluid manipulation using electric fields.

Thus, for example, the present devices can utilize a relatively simple version of the electrowetting electrode array and control circuitry to create, mix, and/or move droplets of sample material. In such devices, a liquid sample is applied upstream of a solid phase material which bears a signal detection zone. If the sample includes cells from which it is desirable to separate the liquid, the cells can be immobilized (e.g., using a binding to specific binding moieties such as antibodies) and a volume of the liquid moved away from the cells. A small volume of liquid from the sample can be mixed with binding reagent and/or other desired reagents in various ways, e.g., by pre-mixing reagent with sample, by passing the liquid through a reagent pad, or by passing liquid over or through a portion of the solid phase material on which the reagent has been dried. Advantageously the sample liquid encounters binding reagent within the region where the electrowetting fluid manipulation is performed. Following the last mixing, a small volume of liquid is moved into contact with the solid phase material. The liquid transits that material (usually by capillary action), encountering a line(s) or zone(s) where analyte becomes immobilized. Usually the line or zone is created by immobilizing a suitable member of a specific binding pair (e.g., an antibody) on the solid phase material. Liquid passes over the signal detection line or zone, typically into a fluid sink, which may include an absorbent material. In most cases, a detection moiety is used (e.g., conjugated with a specific binding moiety which links the detection moiety with analyte) which becomes immobilized with analyte at the signal detection line or zone. Detection of signal at that line or zone indicates the presence and/or amount of the particular analyte in the sample.

In some cases the strip assay device includes it own read-out. Thus, for example, the device may provide a direct detection label, such as a colorimetric label, or may include components to utilize an indirect detection label, such as a fluorescent label. Thus, in devices using a fluorescent labels, the device can include a light source (e.g., an LED) which emits light of a suitable wavelength to generate the fluorescent signal.

Similar to the electrowetting approach, a magnetofluidic approach may be used, e.g., as described in Garcia et al., US Pat Appl Publ 2008/0213853, or in Brauner et al., US Pat Appl Publ 2008/0220539, both of which are incorporated herein by reference in their entireties for all purposes, specifically including for description of fluid mixing or other fluid manipulation using magnetic fields.

### G. Application to Detection of Markers

The present assay reagents, methods, and/or assay platform can readily be applied to a variety of different applications, e.g., for cardiac disease marker detection. Such detection may be laboratory-based, office-based, or home use. For example, the invention may be applied to Congestive Heart Failure (CHF), even as a home monitoring assay system that aids in stabilizing CHF patients at home. Examples of applications include Brain natriuretic peptide (BNP); pro-hormone precursor (proBNP); N-terminal proBNP α α 1-76 (NT-proBNP, the inactive cleavage product); BNP α α 77-108 (the biologically active peptide), Creatine Kinase-MB (CKMB), Myoglobin, CK isoforms (CKMB2 and CKMB1), Troponins (Troponin I (cTnI), Troponin T (cTnT)), Oxidised LDL/B2GPI, Oxidised HDL, CRP, Cytokines, Plaque specific antigens, Adhesion Molecules (e.g. E-selectin), Glutathione, Lipoprotein A, Platelet activation factors, Urinary TxB₂ and Myleoperoxidase. Many other markers may also be used.

### H. Definitions

The term “label” is used in a manner common for biological or biochemical assays, and refers to a moiety of a molecule or complex that is directly or indirectly detectable in a manner providing detection of the presence or amount of the label present. Examples include fluorophores, chemiluminescent moieties, light absorbing moieties, resonance light scattering particles, enzymes, and the like, as well as specific binding moieties such as biotin which can be used to link another moiety for detection. As used herein, the term “detectable label” is equivalent to the term “label”. Indication that a label is “directly detectable” means that the label is directly involved in signal generation (e.g., a fluorophone or a moiety having characteristic light absorbing, reflecting, or scattering properties, or a radioactive moiety). In contrast, an “indirectly detectable” label requires the presence of at least one additional substance for a detectable signal to be generated. Examples of indirectly detectable labels include an enzyme which reacts with a substrate to produce a colored, fluorescent, or chemiluminescent species, and a specific binding moiety which specifically binds with the other of a specific binding pair thereby associating a signal generating substance or moiety with the indirect label.

The phrase “labels interact to provide a signal indicative of said interaction” and similar terms indicate that there is a transfer between two or more labels such that a signal can be detected that differs in level and/or type from a signal (if any) present in the absence of the interaction between the labels. The transfer between labels may be of various types, including, for example, chemical (such as singlet oxygen diffusing to a chemiluminescer, or one enzyme label producing a substrate for another enzyme), or energy (such as energy transfer between fluorescent labels). In some cases, the presence of the interaction signal functions as a proximity label indicating that the interacting labels are close together (the distance may depend on the characteristics of the labels).

The term “full-coated label” refers to a construct, often a particle, which bears or includes detectable moieties and which is either a layered label as defined below or has at least one protein coating which is substantially fully linked to the surface below (i.e., a “fully linked coating label”), e.g., to the particle surface. In most cases, the protein will be fully linked through amines, e.g., such that accessible amines are substantially depleted. In most cases, such a full-coated label has one or more coatings which essentially fully cover the coated particle or interior portions of a layered construct which does not have a solid phase particle core.

The term “layered label” refers to a construct, usually a particle, which bears or includes detectable moieties and which has at least two layers of a polymer material or materials. In many cases, there are covalent links between the layers. In most cases, the layers will be hydrophilic. The layered label may have a core particle, e.g., a polystyrene particle, or may be formed without a core. The detectable moieties may, for example, be covered by the layers, and/or may be distributed in or between layers. For layered labels having a core particle and detectable moieties covered by the layers, detectable moieties may be embedded in the core particles and/or on the surface of the core particles.

The term “staged label” refers to a construct, often a particle, which is protein coated with covalently linked protein. The protein is attached in a manner which essentially depletes functional groups of at least one type in the protein. Additional functional groups are then created in the protein, e.g., by reduction of disulfide bonds. Such constructs, e.g., particles, bear or include detectable moieties. The protein coating has one or more additional moieties linked through —SH groups resulting from reduction of the disulfide bonds or through functional groups derived from such reduced disulfide bonds. Such additional moieties may be of various types, for example, members of specific binding pairs (e.g., antigen for an antigen-antibody pair, or biotin for a streptavidin pair), detectable moieties, or additional coating species, which may be of the same or different protein or of a different type, e.g., a polysaccharide or synthetic polymer.

In reference to solution exchange, the term “displacement” or “displacing” refers to a limited volume solution exchange instead of a full wash, e.g., involving displacement of the prior solution (e.g, a binding solution) with a limited volume of displacement solution (e.g., a reading solution). The solution exchange will generally be limited to displacement of the prior solution with no more than about 2× the volume, commonly no more than about 2.5, 2.0, 1.7, 1.5, 1.4, 1.3, 1.2, 1.1, 1.0 or even less times the volume of the prior solution.

The terms “lateral flow assay” and “strip assay” are used herein equivalently to refer to assay formats, usually immunoassasys, in which the test sample flows along a solid phase substrate (usually a membrane, which may be adhered to a backing material impervious to the liquid used in the assay) via capillary action from a sample application zone into a fluid sink. The sample encounters a detection reagent (commonly dried in a reagent pad downstream of the sample application zone; commonly a coloured reagent) which mixes with the sample and transits the solid phase substrate encountering one or more lines or zones which have been pretreated with an appropriate specific binding moiety (typically an antibody or antigen). Depending upon the analytes present in the sample the detection reagent can become bound at the test line or zone. After passing over the detection lines or zones, the fluid goes into a fluid sink (commonly an absorbent material).

In the present context, the term “separation moiety” or “complex separation moiety” refers to a portion or component of a molecule (e.g., a specific binding reagent)t that allows that molecule or a complex including such molecule to be immobilized or retarded (e.g., in a liquid flow) or moved. This allows, for example, displacement of the liquid around the molecule or complex can be by a new liquid. A particular example is a magnetic particle or material.

The term “wet assay” as used herein means an assay performed in or on a solid phase assay device in which reagents are added to the assay device in solution or suspension form as contrasted to a dry assay in which assay reagents are dried in the assay device, generally in an absorbent reagent pad. In most such dry assays, the sample is added in solution but binding and signal generation reagents are present in dry form and are reconstituted by the sample solution.

As used in connection with this invention, the term “field mixing” refers to mixing of fluids using varying electrical and/or magnetic fields, usually using droplets of the fluid. Similarly, the term “field fluid manipulation” refers to manipulation of a fluid using electrical and/or magnetic fields, e.g., mixing, movement, and/or droplet formation.

The term “analyte” is used herein in the usual manner for in vitro biological assays, referring to a substance, e.g., an ion, molecule, or complex, which is detected and/or quantitated or at least intended to be detected and/or quantitated in an assay.

As used herein, the term “analyte-specific binding reagent” and “analyte-binding agent” refer to a molecule or complex that specifically binds to desired analyte, and may also include moieties having other functions, such as labeling the molecule or complex. In some, but not all embodiments, the analyte-binding agent undergoes a detectable structural change upon binding analyte (e.g., an allosteric structural change).

The term “antibody” is used herein in the broadest sense and is intended to include intact monoclonal antibodies and polyclonal antibodies, as well as derivatives, variants, fragments and/or any other modification thereof so long as they exhibit the desired binding activity. Antibodies encompass immunoglobulin molecules and immunologically active portions of immunoglobulin (Ig) molecules, i.e., molecules that contain an antigen binding site that specifically binds (immunoreacts with) an antigen. These include, but are not limited to, polyclonal, monoclonal, chimeric, single chain, Fc, Fab, Fab′, and Fab₂ fragments, and a Fab expression library. Antibody molecules relate to any of the classes IgG, IgM, IgA, IgE, and IgD, which differ from one another by the nature of heavy chain present in the molecule. These include subclasses as well, such as IgG1, IgG2, and others. The light chain may be a kappa chain or a lambda chain. Reference herein to antibodies includes a reference to all classes, subclasses, and types. Antibodies may be derived from a variety of sources, e.g., human, goat, mouse, rabbit, rat, sheep, camellid, and shark among others. Also included are chimeric antibodies, for example, monoclonal antibodies or modifications thereof that are specific to more than one source, e.g., a mouse or human sequence. Further included are camelid antibodies or nanobodies. Antibodies also include multi-specific, e.g., bispecific (e.g., multivalent, or multimeric) antibodies and functional fragments thereof. It will be understood that each reference to “antibodies” or any like term, herein includes intact antibodies, as well as any modifications thereof.

The term “bound-state binding agent” refers to a specific binding entity, usually a molecule or complex, which preferentially binds to a complex of analyte-binding agent and analyte rather than to either unbound analyte-binding agent or unbound analyte. Bound-state binding agents may, for example, be antibodies, receptors, receptor ligands or analogs thereof, enzymes, enzyme substrates or analogs thereof, or tranporters.

The term “ligand” is used herein to refer to a molecule that binds to another molecule or other chemical entity to form a larger complex. In some cases, a ligand is a soluble hormone or neurotransmitter which binds to a receptor, a molecule to be transported by a transporter protein, and the like. Unless indicated to the contrary in a particular context, the term “ligand” as used herein includes enzyme substrates, inactive substrate analogs, and molecules which bind in a substrate binding site of an enzyme causing detectable conformational changes in the enzyme (preferably substantially the same conformational changes as the native substrate), receptor ligands, transporter ligands, and analogs of the various types of ligands (e.g., receptor or transporter ligands) which bind at a normal ligand binding site and cause detectable conformational changes (preferably substantially the same conformational changes as caused by the native ligand for that binding site). Such ligand analogs may or may not elicit the same or substantially the same biological effect upon binding in vivo as the native ligand.

In the present context, the term “separation moiety” or “complex separation moiety” refers to a portion or component of a molecule (e.g., a specific binding reagent) that allows that molecule or a complex including such molecule to be immobilized or retarded (e.g., in a liquid flow) or moved. A particular example is a magnetic particle or material or a member of a specific binding pair.

The term “small molecule” is used herein to mean a molecule or conjugate which has a molecular weight of 1500 daltons or less, often 1000, 900, 800, 700, 600, 500, 400, or 300 daltons or less.

In connection with this invention, the term “fluid” refers to a liquid, e.g., an aqueous liquid.

As used herein In the context of exciting illumination, the term “oscillating” means the light is repeatedly alternated between higher and lower intensities, often between an “on state” and an “off state”, where the off state has zero or substantially zero intensity.

The term “reflective configuration” for a signal detector refers to an arrangement of exciting illumination and luminescent signal detection in which both the illumination source (e.g., LED) and the photo sensor are located on the same side of the sample from which signal is being detected, e.g., on the same side of a lateral flow strip, array chip, well, flow channel, or the like. In some impementations, the light emitted from the label moieties is collected and delivered to a photosensor using a mirror arrangement. In some configurations, excitation light is directed to the sample by a mirror and light emitted from luminescent labels is collected by a mirror and directed to a photosensor; the mirrors may be twinned, i.e., linked together. Such a twin mirror configuration may be used, for example, when both the light source and the photosensor are in substantially the same plane, e.g., on a circuit board.

As distinguished from a “reflective configuration” a “transmissive configuration” for a signal detector refers to an arrangement of exciting illumination and luminescent signal detection in which the illumination source (e.g., LED) and photosensor are on the same side of the sample, e.g, same side of a lateral flow strip, array chip, well, flow channel, or the like.

A “combination reflective and transmissive configuration refers to a configuration in which luminescent signal detectors are positioned both on the illumination side and the side opposition the illumination (and potentially also an additional side or sides). It should be recognized exciting illumination sources can also be positioned on more than one side of the sample location.

All patents and other references cited in the specification are indicative of the level of skill of those skilled in the art to which the invention pertains, and are incorporated by reference in their entireties, including any tables and figures, to the same extent as if each reference had been incorporated by reference in its entirety individually.

One skilled in the art would readily appreciate that the present invention is well adapted to obtain the ends and advantages mentioned, as well as those inherent therein. The methods, variances, and compositions described herein as presently representative of preferred embodiments are exemplary and are not intended as limitations on the scope of the invention. Changes therein and other uses will occur to those skilled in the art, which are encompassed within the spirit of the invention, are defined by the scope of the claims.

It will be readily apparent to one skilled in the art that varying substitutions and modifications may be made to the invention disclosed herein without departing from the scope and spirit of the invention. For example, variations can be made to the detectable labels used, as well as to the solutions in which the assays are carried out and the apparatus for performing and/or reading the assays. Thus, such additional embodiments are within the scope of the present invention and the following claims.

The invention illustratively described herein suitably may be practiced in the absence of any element or elements, limitation or limitations which is not specifically disclosed herein. Thus, for example, in each instance herein any of the terms “comprising”, “consisting essentially of” and “consisting of” may be replaced with either of the other two terms. The terms and expressions which have been employed are used as terms of description and not of limitation, and there is no intention that in the use of such terms and expressions of excluding any equivalents of the features shown and described or portions thereof, but it is recognized that various modifications are possible within the scope of the invention claimed. Thus, it should be understood that although the present invention has been specifically disclosed by preferred embodiments and optional features, modification and variation of the concepts herein disclosed may be resorted to by those skilled in the art, and that such modifications and variations are considered to be within the scope of this invention as defined by the appended claims.

In addition, where features or aspects of the invention are described in terms of Markush groups or other grouping of alternatives, those skilled in the art will recognize that the invention is also thereby described in terms of any individual member or subgroup of members of the Markush group or other group.

Also, unless indicated to the contrary, where various numerical values or value range endpoints are provided for embodiments, additional embodiments are described by taking any 2 different values as the endpoints of a range or by taking two different range endpoints from specified ranges as the endpoints of an additional range. Such ranges are also within the scope of the described invention.

Thus, additional embodiments are within the scope of the invention and within the following claims.

1-91. (canceled)

92. An assay reader for a biological assay for determining intensity of phosphorescence corresponding to the presence or amount of an analyte in a sample, comprising
a controller which generates a control signal which is the product of two oscillations, a fast oscillation with a period shorter than the phosphorescence decay time of a label to be used in said assay and a slow oscillation with a period substantially longer than the phosphorescence decay time of said label, wherein said fast modulation is between a substantially zero level and a non-zero level and wherein the waveform of said control signal remains positive throughout its period;
an ultra-violet LED selected and configured for optical excitation of a sample in said assay, the output brightness of which is modulated, including alternating off and on intervals, by an electronic circuit in response to said control signal;
a photodiode detector which receives luminescence emitted by said sample following said excitation and generates a detector signal;
a processor which demodulates the detector signal with respect to first high and then low frequency control signals, wherein said processor removes signal corresponding to fluorescence and other signal components corresponding to said non-zero level of said fast modulation, and wherein said processor includes a high gain amplifier which preferentially amplifies signal modulated at approximately the frequency of said slow oscillation and wherein the amplified signal is demodulated and filtered thereby removing signal components due to parasitic effects resulting in a signal output that depends only on the phosphorescence of the sample in said assay.

93. The reader of claim 92, wherein said detector is a point of care detector.

94. The reader of claim 92, further comprising an optical filter between said LED and said sample, wherein said optical filter removes light emitted from said LED having approximately the wavelength of said phosphorescence.

95. The reader of claim 92, further comprising an optical filter between said sample and said photodiode detector, said optical filter being configured to block radiation having wavelengths different from the wavelengths associated with said phosphorescence.

96. The reader of claim 92, wherein said LED emits radiation having a wavelength of between 300 and 400 nm.

97. The reader of claim 92, wherein said slow oscillation is about 10 Hz.

98. The reader of claim 92, wherein said slow oscillation is about 5 Hz.

99. The reader of claim 92, wherein said slow oscillation is 10 Hz or slower.

100. The reader of claim 92, wherein said fast oscillation is 1 kHz or higher.

101. The reader of claim 92, wherein said fast oscillation is greater than the reciprocal of the phosphorescence decay time of the label.

102. The reader of claim 92, wherein said slow oscillation is selected to be different than the frequency of dynamic sources of interfering light and harmonics thereof, including incandescent and fluorescent lights.

103. The reader of claim 92, wherein said off period of said LED is short in comparison to the phosphorescence decay time of said label.

104. The reader of claim 92, wherein said slow oscillation is a sinusoidal signal.

105. The reader of claim 92, wherein said slow oscillation is a rectangular wave signal.

106. The reader of claim 92, wherein said fast oscillation is a sinusoidal signal.

107. The reader of claim 92, wherein said fast oscillation is a rectangular wave signal.

108. A method for detecting the presence or amount of an analyte in a sample, comprising
inserting an assay device containing a biological sample in a reader as specified in claim 92;
combining said sample with a phosphorescent label, and
detecting a phosphorescent signal from said label separate from fluorescence, wherein the detected phosphorescent signal is indicative of the presence and/or amount of the analyte in said sample.
